(19) United States
(12) Patent Application Publication
(10) Pub. No.: US 2025/0172913 A1
(43) Pub. Date: May 29, 2025

(54) Automaton-Based Controller and Method with Generative Language Models for Task Execution

(71) Applicant: BOARD OF REGENTS, THE UNIVERSITY OF TEXAS SYSTEM, Austin, TX (US)

(72) Inventors: Ufuk Topcu, Austin, TX (US); Yunhao Yang, Austin, TX (US); Cyrus Neary, Austin, TX (US); Jean-Raphael Gaglione, Austin, TX (US)

(21) Appl. No.: 18/958,684

(22) Filed: Nov. 25, 2024

Related U.S. Application Data
(60) Provisional application No. 63/602,380, filed on Nov. 23, 2023.

(51) Int. Cl. G05B 13/02

(52) U.S. Cl. CPC G05B 13/0265

(57) ABSTRACT

An exemplary system and method that generate a finite state automaton of a controller for sequential decision-making of a computing device for a user-requested task, the generation using automaton-based representations derived from outputs of a large-scale generative language model. The exemplary system and method receive a user command and (i) construct the finite state automaton by parsing GLM responses to prompts/queries for candidate steps and sub-steps for the task, and (ii) verify the finite state automaton, e.g., for logical errors, safety specification, performance specification, and intent of the user, and/or update the finite state automaton to meet such specifications. The state machine can be synthesized on the fly for real-time operation via the GLM outputs and evaluated in the same pipeline operation against physical models, safety models, etc., that can be combined to iteratively modify the state machine until it meets the verification requirements.

### RELATED APPLICATION

This U.S. application claims priority to, and the benefit of, U.S. Provisional Patent Application No. 63/602,380, filed Nov. 23, 2023, entitled “Automaton-Based Controller and Method with Generative Language Models for Task Execution,” which is incorporated by reference herein in its entirety.

### STATEMENT OF GOVERNMENT SUPPORT

This invention was made with government support under grant numbers CNS1652113 and CNS1836900 awarded by the National Science Foundation. The government has certain rights in the invention.

### BACKGROUND

A state machine describes the behavior of a controller. A state machine (also called a Finite State Machine or FSM) is a controller that can be in a finite number of different states. Design engineers employ state machines for various control systems to handle complex and dynamic situations. The work can be manually intensive.

There is a benefit to improving the design and generation of state machines.

### SUMMARY

An exemplary system and method are described that generate a finite state automaton (FSA) of a controller for sequential decision-making of a computing device for a user-requested task, the generation using automaton-based representations derived from outputs of a large-scale generative language model (GLMs). The exemplary system and method receive a user command (written or verbal) and (i) construct the finite state automaton by parsing GLM responses to prompts/queries for candidate steps and sub-steps for the task, and (ii) verify the finite state automaton, e.g., for logical errors, safety specification, performance specification, and intent of the user, and/or update the finite state automaton to meet such specifications. Notably, the state machine can be synthesized on the fly for real-time operation via the GLM outputs and evaluated in the same pipeline operation against physical models, safety models, etc., that can be combined to iteratively modify the state machine until it meets the verification requirements.

A finite state automaton, also referred to as a finite state machine (FSM), is a mathematical model for sequential decision-making by the controller.

To construct the finite state automaton, the exemplary system and method can send, in a pipeline operation, a set of queries to a GLM to extract task knowledge in textual form from the GLM and then build the initial and modified FSA. The FSA are then evaluated against one or more models (derived from the GLM or pre-stored model) and user-defined specification that can call out logical errors, safety specification, performance specification, and/or intent of the user. To modify the finite state automaton, the exemplary system and method can refine the queries to the GLM-based counter-examples or expand/prune states of the state machine using information derived from the verification operation.

The exemplary system and method can be employed in low-level device controls and high-level system controls, e.g., in navigations (e.g., to generate navigation tasks), operating systems (e.g., to generate action tasks), autonomous system control (e.g., to generate control tasks), automated software assistants (e.g., *Siri* and *Google Assistant*). The exemplary system and method can broadly capture task knowledge, via the use of GLMs, for the construction of an automaton-based representation (e.g., in an automaton-based controller or state machine) without prior knowledge of a task and ensure there are no undesirable or nonsensical outputs from the GLM.

In an aspect, a method is disclosed for a human-machine interface (robotic system or digital robot) comprising: receiving text data associated with a command (e.g., verbal or written command) of a user having a natural language sentence (e.g., natural language instructions) for a task of interest; generating, via a controller engine in a pipeline operation performed by the controller generation engine, using the received text data as a task of interest, an automaton controller configured to perform constrained sequential decision-making for the task of interest; and outputting the finite state automata as a state machine for the automaton controller if the checked data structure satisfies the set of pre-defined one or more requirements, wherein the automaton controller is employed as a part of executable instructions to direct machine processes or equipment to perform the task of interest.

The step of generation includes iteratively querying, in the pipeline operation, a trained generative language model with one or more structured-natural-language queries for (i) a task of interest and (ii) a step-by-step task instruction description, wherein a natural-language description and the step-by-step task instruction description are arranged as a structured hierarchy of steps and substeps for the task of interest; parsing, for language phrase objects (e.g., noun objects, verb objects) and transition objects, (i) the natural-language description to generate a set of first textual data objects and (ii) the step-by-step task instruction description to generate a set of second textual data objects; generating a finite state automaton, as linear temporal logic, comprising a data structure (e.g., tuple, tree, object-oriented data class) that includes at least (i) input data objects corresponding to actions for a task, (ii) output data objects corresponding to environment observations, (iii) initial stage, and (iv) transition function; and determining, in a verification operation, whether finite state automata satisfy a set of one or more pre-defined requirements maintained by a constraint engine, wherein the verification operation checks the data structure against the set of pre-defined requirements.

In some embodiments, the method further includes revising the finite state automata if the checked data structure is deficient in satisfying the set of pre-defined one or more requirements, wherein the revision employs adding supplemental data structure based on a counter-example explaining controller deficiency.

In some embodiments, the method further includes determining an output associated with the counter-example; and generating the output (via a graphical user interface or voice command) to the user associated with the counter-example.

In some embodiments, the method further includes iteratively querying, in the pipeline operation, the trained generative language model for an output associated with the counter-example.

In some embodiments, the verification operation, or a separate refinement operation, iteratively expands the substeps for the task of interest until the checked data structure satisfies the set of pre-defined one or more requirements or until a maximum depth is reached.

In some embodiments, the step of iteratively querying further includes: parsing, via a first operation, the first textual data object to extract keywords, including verb phrases and connective keywords, to define atomic propositions, output symbols, and transitions.

In some embodiments, the one or more structured natural-language queries are generated via an algorithm that: (i) generates a first query string based on an extracted portion associated with the task of interest of the received text data; (ii) receives a set of one or more responses, as step objects, from the trained generative language model, as the first textual data object; (iii) iteratively generates, for each response of the received set of one or more responses, a second query string derived from the respective response; and (iv) receives a set of one or more responses, as substep objects, from the trained generative language model as the second textual data object.

In some embodiments, the transition function includes direct transition, conditional transition, and self-transition.

In some embodiments, the one or more structured-natural-language queries include a domain-specific knowledge indicator or constraint.

In another aspect, a system is disclosed comprising: a processor; and a memory having instructions stored thereon to execute a human-machine interface (robotic system or digital robot), wherein execution of the instructions by the processor causes the processor to: receive text data associated with a command of a user having a natural language sentence (e.g., natural language instructions received as a verbal or written command from the user) for a task of interest; generate, via a controller engine in a pipeline operation performed by the controller engine using the received text data as a task of interest, an automaton controller configured to perform constrained sequential decision-making for the task of interest; and output the finite state automata as a state machine for the automaton controller if the checked data structure satisfy the set of pre-defined one or more requirements, wherein the automaton controller is employed as a part of executable instructions to direct machine processes or equipment to perform the task of interest.

The generation includes: iteratively query, in the pipeline operation, a trained generative language model with one or more structured-natural-language queries for (i) a task of interest and (ii) a step-by-step task instruction description, wherein natural-language description and the step-by-step task instruction description are arranged as a structured hierarchy of steps and substeps for the task of interest; parse, for language phrase objects (e.g., noun objects, verb objects) and transition objects, (i) the natural-language description to generate a set of first textual data objects and (ii) the step-by-step task instruction description to generate a set of second textual data objects; generate a finite state automaton comprising a data structure (e.g., tuple, tree, object-oriented data class) that includes at least (i) input data objects corresponding to actions for a task, (ii) output data objects corresponding to environment observations, (iii) initial stage, and (iv) transition function; and determine, in a verification operation, whether finite state automata satisfy a set of one or more pre-defined requirements maintained by a constraint engine, wherein the verification operation checks the data structure against the set of pre-defined requirements.

In some embodiments, the instructions further cause the processor to: revise the finite state automata if the checked data structure is deficient in satisfying the set of pre-defined one or more requirements, wherein the revision employs adding supplemental data structure based on a counter-example explaining controller deficiency.

In some embodiments, the instructions to revise the finite state automata include: instructions to determine an output associated with the counter-example; and instructions to generate the output (via a graphical user interface or voice command) to the user associated with the counter-example.

In some embodiments, the instructions to revise the finite state automata include: iteratively query, in the pipeline operation, the trained generative language model for an output associated with the counter-example.

In some embodiments, the verification operation, or a separate refinement operation, iteratively expands the substeps for the task of interest until the checked data structure satisfies the set of pre-defined one or more requirements or until a maximum depth is reached.

In some embodiments, the instruction to iteratively query includes: instructions to parse, via a first operation, the first textual data object to extract keywords, including verb phrases and connective keywords, to define atomic propositions, output symbols, and transitions.

In some embodiments, the one or more structured natural-language queries is generated via an algorithm that: (i) generates a first query string based on an extracted portion associated with the task of interest of the received text data; (ii) receives a set of one or more responses, as step objects, from the trained generative language model, as the first textual data object; (iii) iteratively generates, for each response of the of the received set of one or more responses, a second query string derived from the respective response; and (iv) receives a set of one or more responses, as substep objects, from the trained generative language model as the second textual data object.

In some embodiments, the transition function includes direct transition, conditional transition, and self-transition.

In some embodiments, the one or more structured-natural-language queries include a domain-specific knowledge indicator or constraint.

In another aspect, a non-transitory computer-readable medium is disclosed having instructions stored thereon to execute a human-machine interface (robotic system or digital robot), wherein execution of the instructions by a processor causes the processor to: receive text data associated with a command of a user having a natural language sentence (e.g., natural language instructions received as verbal or written command from a user) for a task of interest; generate, via a controller engine in a pipeline operation performed by the controller engine using the received text data as a task of interest, an automaton controller configured to perform constrained sequential decision-making for the task of interest; and output the finite state automata as a state machine for the automaton controller if the checked data structure satisfies the set of pre-defined one or more requirements, wherein the automaton controller is employed as a part of executable instructions to direct machine processes or equipment to perform the task of interest.

The generation includes: iteratively query, in the pipeline operation, a trained generative language model (GLM) with one or more structured-natural-language queries for (i) a task of interest and (ii) a step-by-step task instruction description, wherein natural-language description and the step-by-step task instruction description are arranged as a structured hierarchy of steps and substeps for the task of interest; parse, for language phrase object (e.g., noun objects, verb objects) and transition objects, (i) the natural-language description to generate a set of first textual data objects and (ii) the step-by-step task instruction description to generate a set of second textual data objects; generate a finite state automaton, as linear temporal logic, comprising a data structure (e.g., tuple, tree, object-oriented data class) that includes at least (i) input data objects corresponding to actions for a task, (ii) output data objects corresponding to environment observations, (iii) initial stage, and (iv) transition function; and determine, in a verification operation, whether finite state automata satisfy a set of one or more pre-defined requirements maintained by a constraint engine, wherein the verification operation checks the data structure against the set of pre-defined requirements.

In some embodiments, the instructions further cause the processor to revise the finite state automata if the checked data structure is deficient in satisfying the set of pre-defined one or more requirements, wherein the revision employs adding supplemental data structure based on a counter-example explaining controller deficiency.

### BRIEF DESCRIPTION OF THE DRAWINGS

Embodiments of the present invention may be better understood from the following detailed description when read in conjunction with the accompanying drawings. Such embodiments, which are for illustrative purposes only, depict novel and non-obvious aspects of the invention. The drawings include the following figures:

FIGS. 1A-1C each shows an exemplary system configured to generate a finite state automaton for a controller of a computing device for sequential decision-making operations, the generation derived from large-scale generative language models in accordance with an illustrative embodiment.

FIG. 1D shows an example implementation of the controller generation engine in accordance with an illustrative embodiment.

FIG. 2A shows an example algorithm (Algorithm “1”) to implement GLM query generation in accordance with an illustrative embodiment.

FIG. 2B shows an example algorithm (Algorithm “2”) to parse the textual GLM outputs and construct the automata-based controllers in accordance with an illustrative embodiment.

FIG. 2C shows an example FSA in accordance with an illustrative embodiment.

FIG. 2D shows example grammar rules for the generation of an FSA in accordance with an illustrative embodiment.

FIG. 2E shows an example method to perform module checking in accordance with an illustrative embodiment.

FIGS. 3A-3F show an example operation of the Algorithms “1” and “2” of FIGS. 2A and 2B in the context of an example requested task of “crossing the road,” e.g., for an autonomous vehicle controller or self-driving system.

FIGS. 4A-4D shows example operations to verify and modify the finite state automaton in accordance with an illustrative embodiment.

FIGS. 5A-5H and FIG. 6 show an example of controller generation and verification/refinement for the task command “cross the road” conducted in a study.

FIGS. 7A-7F show an example of controller generation and verification/refinement for a task command associated with troubleshooting and debugging in accordance with an illustrative embodiment.

FIG. 8A-8B show an example of controller generation and verification/refinement for a task command associated with scheduling a task in accordance with an illustrative embodiment.

FIG. 9A-9B show an example of controller generation and verification/refinement for a task command associated with multi-party computation coordination in accordance with an illustrative embodiment.

FIGS. 10A-10B show example controller generation for task command associated with vehicle control in accordance with an illustrative embodiment.

FIGS. 11A-11C shows an example controller generation for task command associated with robot controls in accordance with an illustrative embodiment.

### DETAILED SPECIFICATION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

### Example System

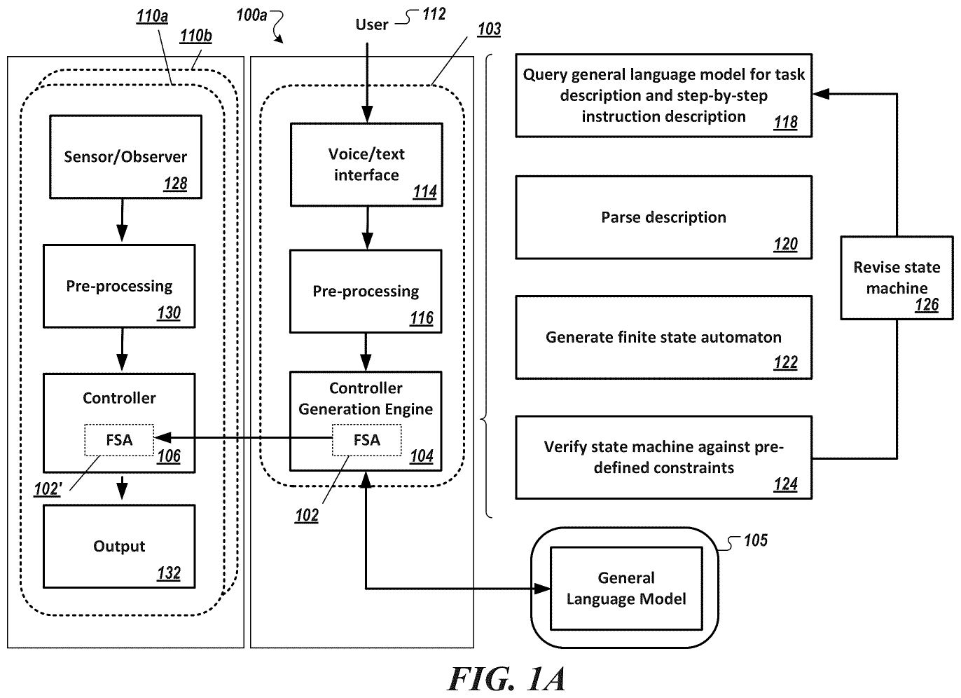

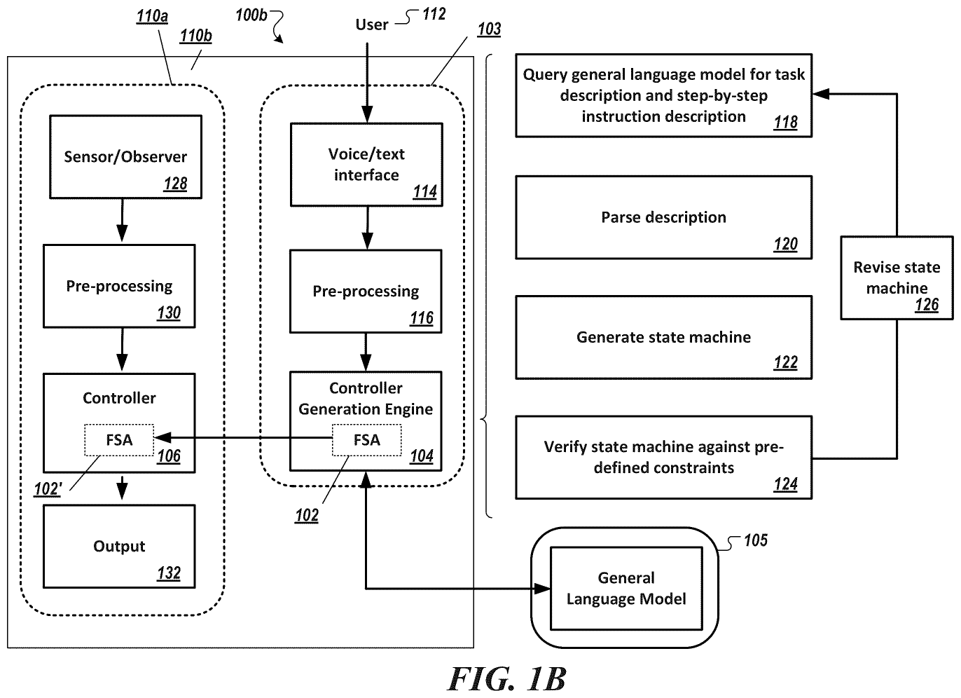

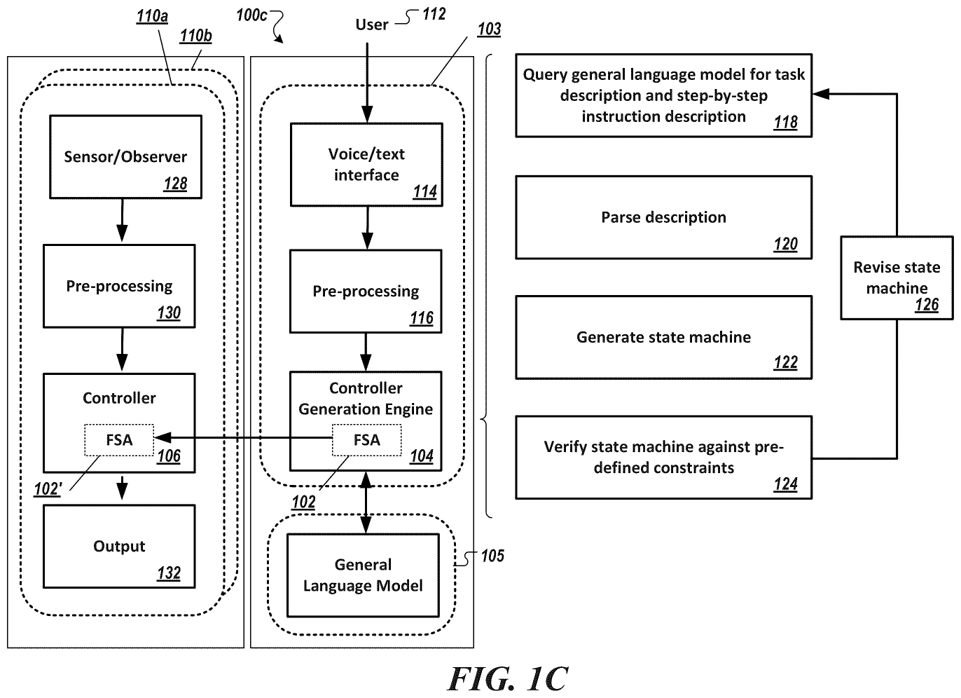

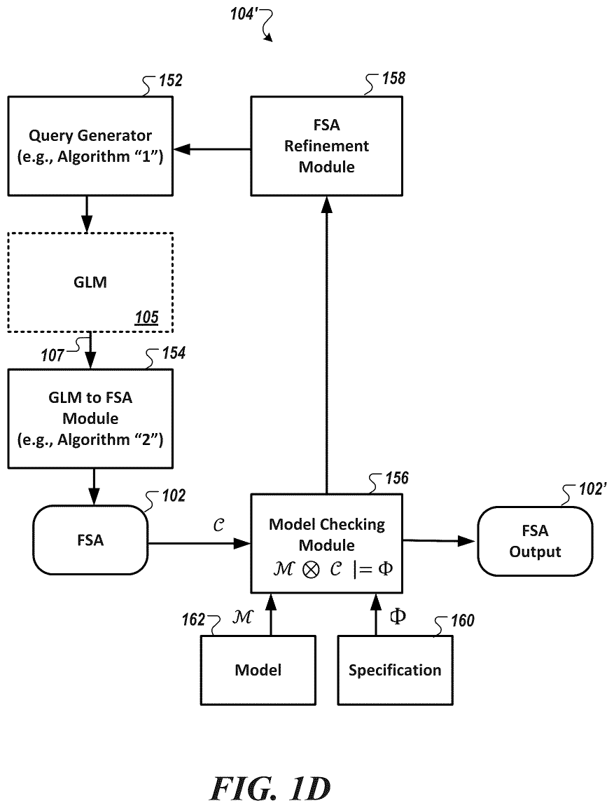

FIGS. 1A, 1B, 1C each shows an exemplary system 100 (shown as 100a, 100b, 100c) configured to generate a finite state automaton (FSA) 102 for a controller 106 of a computing device 110 for sequential decision-making operations, the generation derived from large-scale generative language models (GLMs) in accordance with an illustrative embodiment.

In the example shown in FIG. 1A, the system 100a includes a human-machine interface 103 comprising a controller generation engine 104 configured to operate with a generative language model 105 to generate the controller 106 for operating, via a controller environment (shown as 110a, 110b) of the computing device, a task 108 requested from a user 112. FIG. 1B shows the human-machine interface 103 being implemented within the controller environment. FIG. 1C shows the GLM 105 as a part of the human-machine interface 103.

In each of FIGS. 1A, 1B, 1C, the controller generation engine 104 is configured to interrogate a generative language model 105 to construct, from the GLM output, verifiable knowledge representations of given tasks and then formally verify the knowledge representation against pre-defined specifications, e.g., logical accuracy specification, safety specification, performance specification, intent specification of the user, to refine the knowledge representation using the verification outcomes. FIG. 1D shows an example implementation of the controller generation engine 104.

In the example shown in FIG. 1A, the human-machine interface 103 includes a voice or text interface 114, a pre-processing module 116, and a controller generation engine 104. The voice-or-text interface 114 is configured to receive a voice command for a task requested from the user 112. In some embodiments, the voice-to-text interface 114 includes a speech interface configured to record and generate an audio file of a verbal command of the user 112 having a natural language sentence (e.g., natural language instructions) for a task of interest. In other embodiments, the voice-to-text interface 114 includes an interface to receive a textual command for the task from the user 112. In some embodiments, the voice-to-text interface 114 may receive the textual command from an optical recognition module (not shown) that acquired the command from an image acquired via a camera or video camera sensor.

In FIGS. 1A-1C, the controller generation engine 104 is configured to query (118), in the pipeline operation, the generative language model with one or more structured-natural-language queries for (i) a task of interest and (ii) a step-by-step task instruction description, in which the task description and the step-by-step subtask instruction description are arranged as a structured hierarchy of steps and substeps for the task of interest. The engine 104 then parses, e.g., for noun objects, verb objects, transition objects, or user-defined phrase objects, (i) task instruction descriptions to generate a set of first textual data objects and (ii) the step-by-step task instruction description to generate a set of second textual data objects. The controller generation engine 104 then generates (122) the finite state automaton 102 as a data structure (e.g., tuple, tree, object-oriented data class) that includes at least (i) input data objects corresponding to actions for a task, (ii) output data objects corresponding to environment observations, (iii) initial stage, and (iv) transition function. The engine 104 then determines (124), in a verification operation, whether the finite state automata 102 satisfies a set of one or more pre-defined requirements maintained by a constraint engine. The verification operation checks the finite state automata 102 against the set of pre-defined requirements. Based on the verification operation, the engine 104, via the verification operation or a separate refinement operation, can revise (126) the state machine until the finite state automata 102 satisfy the pre-defined requirements or until a maximum condition is met (e.g., maximum number of modifications or maximum number of substeps).

The generative language model 105, in some embodiments, is a large-scale generative language model, e.g., Generative Pre-trained Transformer (GPT) series [6] (which is incorporated by reference herein), configured to generate realistic, human-like text in response to queries as input to the exemplary sequential decision-making or automaton learning. Other GPT or generative language models may be used.

The controller 106 includes a finite state automaton 102. The finite state automaton 102 includes a data structure (e.g., tuple, tree, object-oriented data class) that includes at least (i) input data objects corresponding to actions for a task, (ii) output data objects corresponding to environment observations, (iii) initial stage, and (iv) transition function. Examples of transition functions include direct transition, conditional transition, and self-transition.

The controller environment 110 (shown as 110a, 110b)) is the hardware, middleware, and firmware of a system configured for a function. An example of a controller environment is a navigation software (e.g., Google Maps), or a navigation device (e.g., GPS device). In another example, the controller environment is an operating system (e.g., Microsoft Windows, Google Android, Apple MacOS. In yet another example, the controller environment is a robot control system (e.g., for autonomous vehicles, unmanned autonomous vehicle (UAV)/drones). In yet another example, the controller environment is an automated software assistant such as Apple Siri or Google Assistant. In the example shown in FIG. 1A, the controller environment 110 includes a sensor or observer 128, a pre-processing module 130, and an output 132. The controller environment 110 may include a human-machine interface (e.g., 103).

### Example Controller Generation Engine

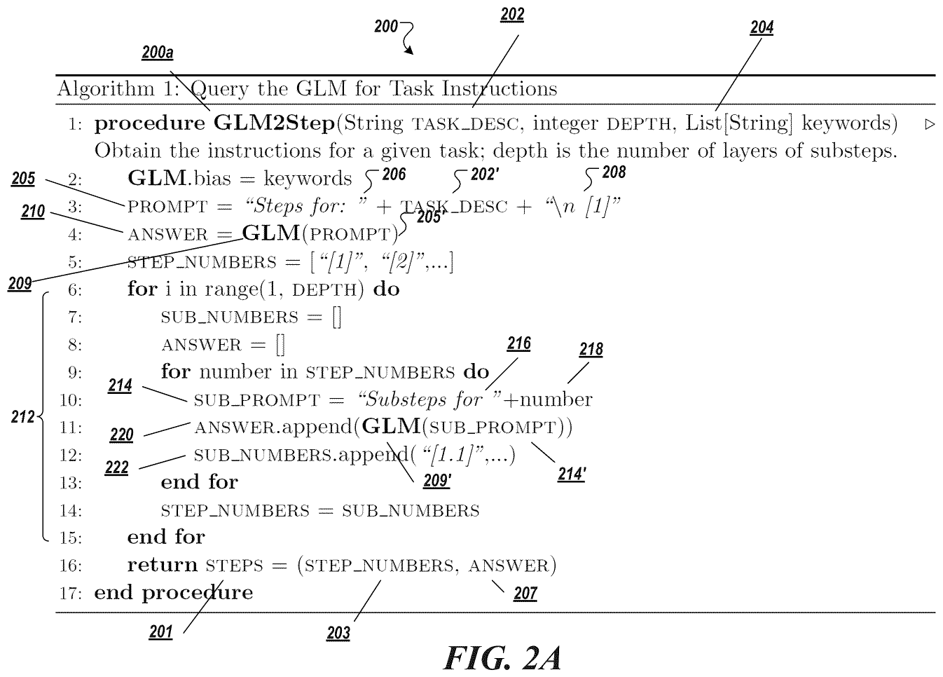

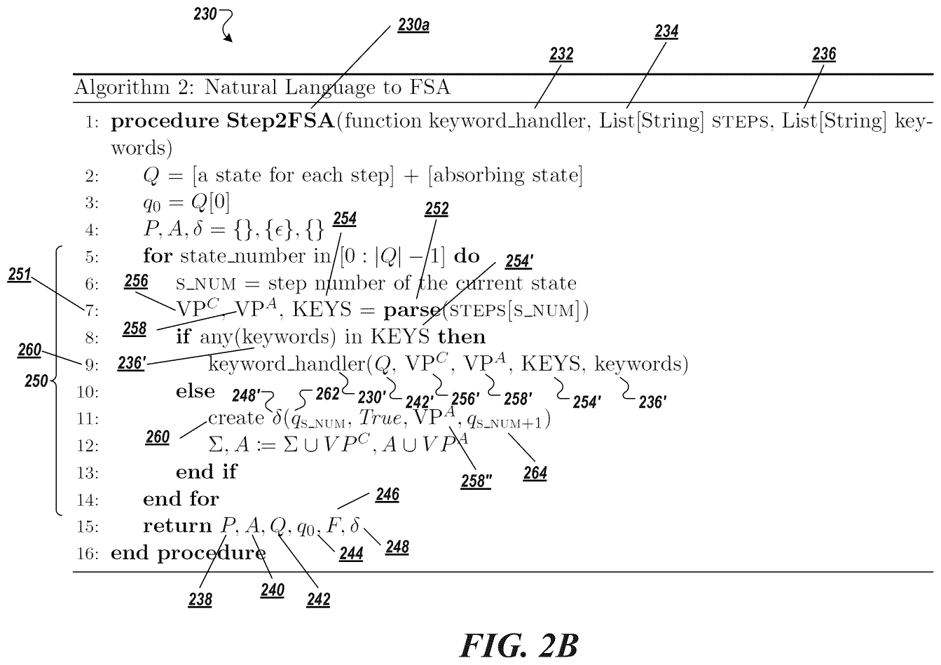

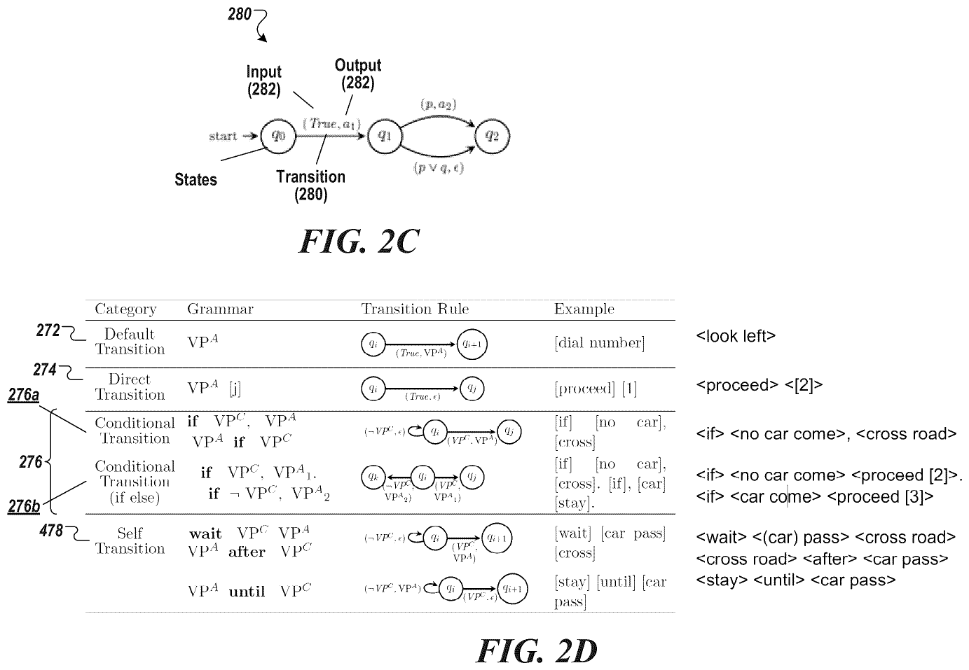

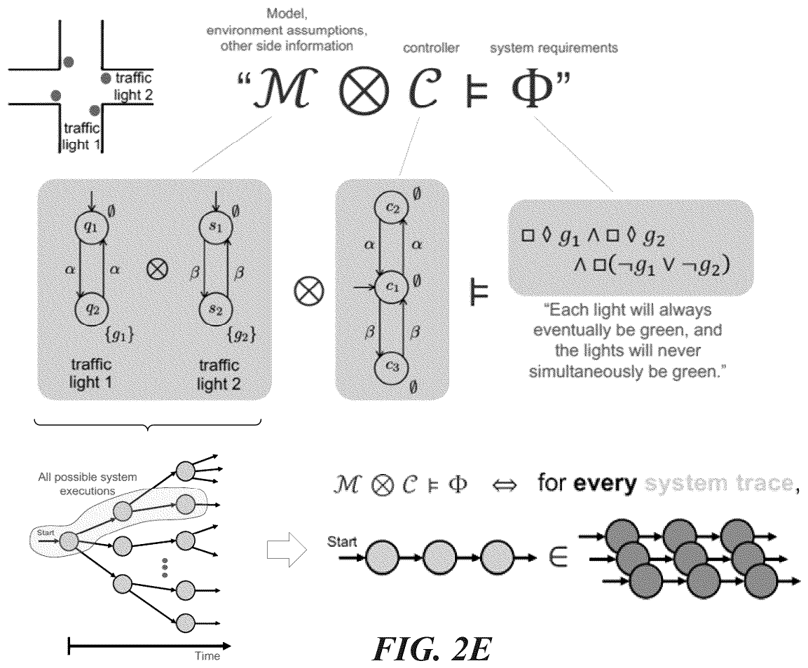

FIG. 1D shows an example controller generation engine 104 (shown as 104′) in accordance with an illustrative embodiment. The controller generation engine 104′ includes a query generator 152 (e.g., implemented via Algorithm “1”) configured to interrogate a generative language model 105 for a GLM response. FIG. 2A shows an example algorithm (Algorithm “1”) to implement GLM query generation (e.g., 118). The controller generation engine 104′ includes a GLM-to-FSA module 154 (e.g., implemented via Algorithm “2”) to construct, from the GLM output 107, verifiable knowledge representations of given tasks and subtasks. FIG. 2B shows an example algorithm (Algorithm “2”) to parse the textual GLM outputs and construct the automata-based controllers. The Algorithm “1” and Algorithm “2” can be implemented as computer readable instructions.

The controller generation engine 104 then formally verifies, via a model checking module 156, the knowledge representation against pre-defined requirements, e.g., logical accuracy specification, safety specification, performance specification, and intent specification of the user, to refine the knowledge representation in the FSA via the refinement module 158 using the verification outcomes. The requirements may include specifications 160 and models 162. The operation of generating the FSA and refining the FSA may be performed in an iterative process within a pipeline operation until the generated FSA meets the prerequisite requirements are met. The iterative process of querying for steps and corresponding substeps allows for the automated decomposition of the task description into a structured hierarchy of steps and substeps up to a pre-specified depth.

### Example GLM Query Generator

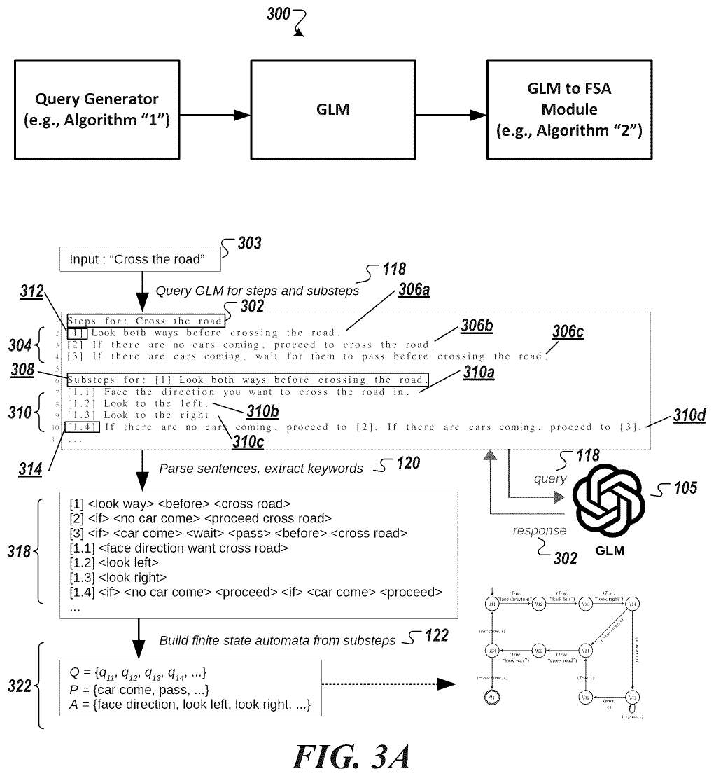

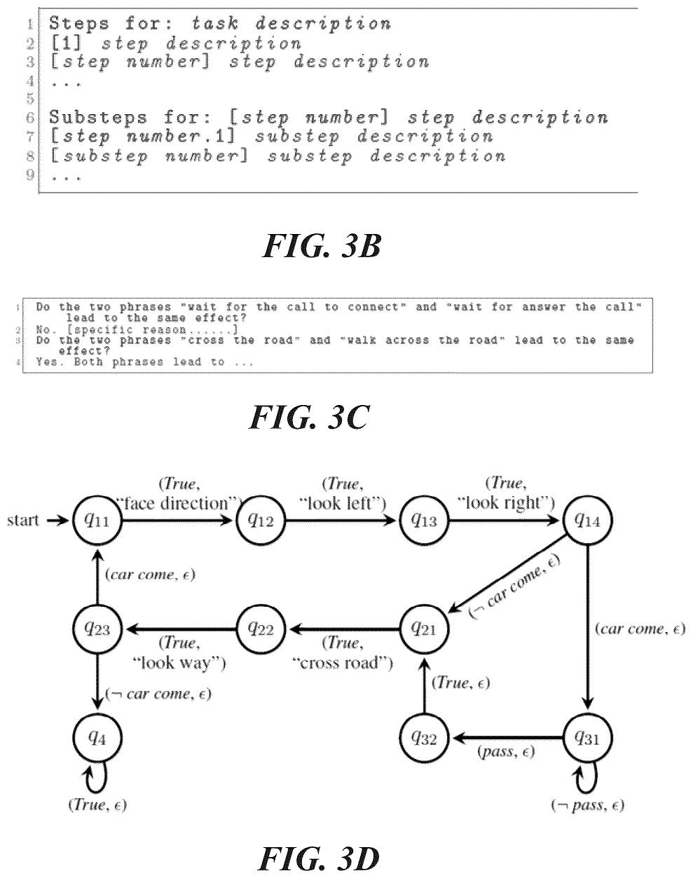

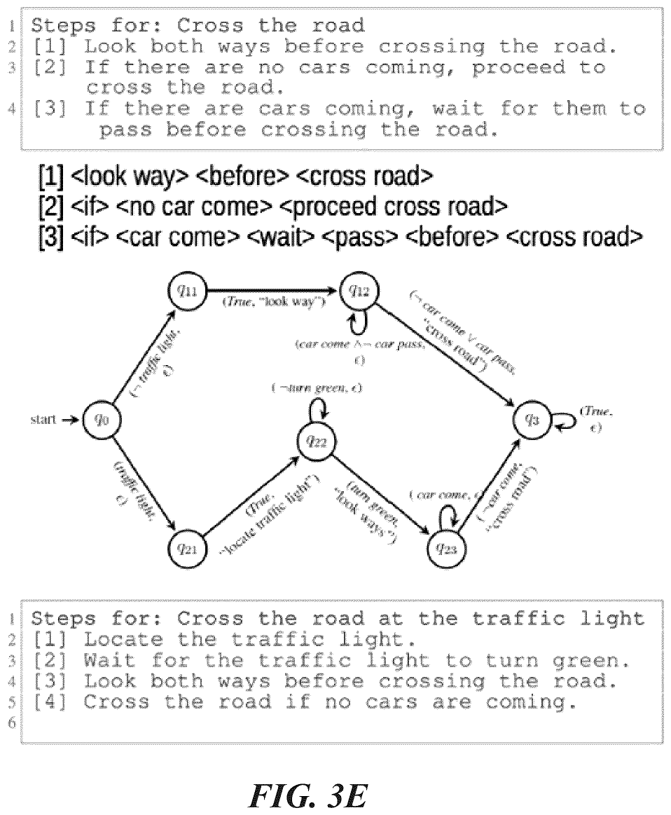

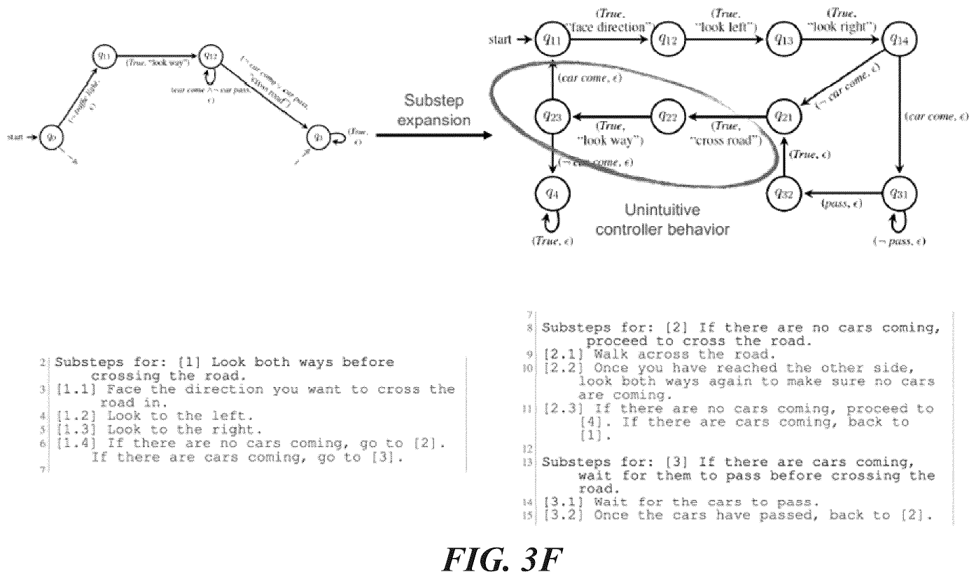

FIG. 2A shows an example algorithm 200 (Algorithm “1” 200) to implement a GLM query generator (e.g., 156) that performs a GLM query generation (e.g., 118). FIGS. 3A-3C show an example operation of the Algorithms “1” in the context of an example requested task of “crossing the road,” e.g., for an autonomous vehicle controller or self-driving system.

In the example shown in FIG. 2A, Algorithm “1” 200, executing the GLM query generator 152, can be used to generate tasks and subtasks inquiries as structured language queries (prompts) to a GLM to distill such task-relevant textual knowledge from the GLM. In FIG. 2A, the Algorithm “1” 200 is configured as a function call (“GLM2Step” 200a) that receives a string task description 202 and a list of keyword strings 204. The maximum depth of the steps can be provided as an input (in the example) or as a static parameter in the algorithm. The output of Algorithm “1,” per line “16,” includes a STEP object 201 having an array of step number 203 and an array of ANSWERS 207. The array of step number 203 corresponds to the step text data 312 and substep text data 314 (FIG. 3A), and the array of ANSWERS 207 corresponds to the step descriptions (e.g., 306a-306c) and the substep descriptions (e.g., 310a-310d) (FIG. 3A).

In FIG. 2A, Algorithm “1” 200a establishes, in line “3,” a PROMPT command 205 to the GLM as a concatenation of a base text “Steps for:” 206, the string task description 202 (shown as 202′), and a new line command 208. Algorithm “1” 200a then calls, in line “4,” the GLM function 209 with a query of the PROMPT command 205 (shown as 205′). The function call GLM 209 returns an ANSWER object 210.

Algorithm “1” 200a then calls “for” loop 212 to establish a set of SUB_PROMPT command (214) to query the GLM for the substep descriptions. Other loop structures can be used, e.g., do loop, while loop, etc. The SUB_PROMPT command (214) is established as a concatenation of a base text “Substeps for:” (216) a number label (218). Algorithm “1” 200a calls the GLM function (shown as 209′) with the SUB_PROMPT command 214 (shown as 214′) and stores the reply in an ANSWER object 220. The algorithm then appends (222) the subtask labels to the reply.

### Example GLM-to-FSA Module

FIG. 2B shows an example algorithm 230 (Algorithm “2” 230a) to parse the textual GLM outputs and construct the automata-based controllers. Algorithm “2” 230a can perform the set of operations, e.g., in a pipeline operation, with Algorithm “1” 200a. FIG. 3D shows an example FSA generated from the Algorithm “2” 230a in the context of the example requested task of “crossing the road.”

In the example shown in FIG. 2B, Algorithm “2” 230, executing the GLM-to-FSA module 156, can (i) take the step and substep descriptions generated by the GLM, which are in textual form and not directly interpretable or employed by a planning or learning algorithms in a sequential decision-making state-machine, and (ii) transform the step and substep descriptions from the textual form to the finite state automata.

In FIG. 2B, Algorithm “2” 230a first parses, e.g., via semantic parsing or other encoding or parsing, each step and substep description to obtain the keywords and verb phrases. The parsing operation can classify the part-of-speech tags [21] of each word in a sentence and build word dependencies based on natural language grammar.

Semantic parsing, as one form of parsing, is a task in natural language processing (NLP) that converts a natural language utterance to a logical form: A machine-understandable representation. In some embodiments, a part-of-speech (POS) tag can be generated for each token in which the tags are employed to build phrase structure depending on phrase structure rules (namely, the grammar). POS tags, in some embodiments, include noun (N), verb (V), adjective (AJD), adverb (ADV), etc. Phrase structures can be expressed as a tree-structured logic in which leaves are the POS tags of the given natural language utterance (i.e., sentence). Phrase structure rules then organize the POS tags into phrases like noun phrases (NP) and verb phrases (VP).

In the example shown in FIG. 2B, the Step2FSA function 230a receives a keyword_handler function 232, a list of STEP strings 234, and a list of KEYWORD strings 236. The outputs of Algorithm “2” 230a includes atomic proposition “P” 238, output symbols “A” 240, state-machine states “Q” 242, initial state “q0” 244, “F” 246, and default transition “δ” 248.

In Algorithm “2” (230a), for each step of “for” loop 250, Algorithm “2” 230a, via line “9”, (i) adds a state qᵢ representing the current step i to FSM states Q, (ii) adds an action verb phrase VP^{A} to the set of output symbols A, and (iii) adds condition verb phrase VP^{C} to the set of atomic propositions P. Algorithm “2” 230a defines the state corresponding to the first step as the initial state q₀. Algorithm “2” 230a also adds, per line “11”, an absorbing state after the state corresponding to the final step. The absorbing state only has one self-transition with input True and output “no operation.”

Algorithm “2” can generate FSAs as a sequential decision-making state machine in which the input alphabet includes all possible environment observations relevant to the current task. The state machine employs a set of atomic propositions P such that Σ:=2^{P}, i.e., an input symbol σ∈Σ is the set of atomic propositions in P that evaluate to True. The state machine also employs a set of atomic propositions P_{A} for the output alphabets A:=2^{P}^{_{A}}. For a propositional logic operator based on these atomic propositions, e.g., φ=¬p∧q where p, q∈P, the transition (qᵢ, φ, a, qⱼ) exists if for all σ∈Σ that satisfies the input symbol φ, the operator δ(qᵢ, φ, a, qⱼ)=1. In other words, if the current state is qᵢ and the condition of the input symbol φ holds, the transition to the next state qⱼ can be determined as output symbol a.

Referring to FIG. 2B, Algorithm “2” 230a in the loop 250 first extracts (251), at line “7”, via a PARSE function 252, the words whose part-of-speech tag is a verb and the dependencies of those words in which each verb with its noun dependency is a verb phrase (VP). The parse(⋅) function 252, in some embodiments, implements a keyword and verb phrase extraction process, e.g., by calling the Python spaCy library for semantic parsing [14], which is incorporated by reference herein. The output, per line “7” of the PARSE is a set of extracted keywords “KEYS” 254 and extracted verb phrases, shown as condition verb phrase VP^{C} (256) and action verb phrase VP^{A} (258), further described below.

Algorithm “2” 230a then maps the parsed noun and verb phrases to pre-defined grammar keywords. The grammar keywords are a pre-defined set of words (e.g., “if” and “wait.”) that the algorithm employs to define the grammar for the automaton construction. In the example shown in FIG. 2B, Algorithm “2” employs an if function to determine if any of a set of provided keywords 236 (shown as 236′) are present in the extracted keywords KEYS 254 (shown as 254′). Algorithm “2” 230a can then interpret the parsed verb phrase as either a condition or an action using transition rules implemented in the keyword_handler function 230 (shown as 230′). The keyword_handler function 230′ receives the state-machine states “Q” 242 (shown as 242′), parsed action verb phrase VP^{A} 258 (shown as 258′), the parsed condition verb phrase 256 (shown as 256′), extracted keywords KEYS 254 (shown as 254′), and provided keywords 236 (shown as 246′). The keyword_handler function (line “9” 260) then transforms the steps and verb phrases into the components of an FSA, namely, the finite set of states Q, the finite set of atomic propositions P, and the finite action set A. If the parsed keywords KEYS 254′ are not in the provided keywords 236′ (in the else function), then a transition function δ 248 (shown as 248′) is created via a create function 260 using the action verb phrase VP^{A} 258 (shown as 258″), state number “q_{s_NUM}” 262, and next state number “q_{s_NUM+1}” 264. Next, Algorithm “2” 230a builds transitions between the states using the various transition rules illustrated in Table 1 (reproduced as FIG. 2D). Other nomenclatures may be used.

A finite state automaton (FSA) may be implemented as a tuple [symbol] = [symbol] Σ, A, Q, q₀, δ [symbol] where Σ is the input alphabet (the set of input symbols), A is the output alphabet (the set of output symbols), q₀∈Q is the initial state, and δ:Q×Σ×A×Q→{0, 1} is the transition function, which indicates that a transition exists when it evaluates to 1. The FSAs transitions are non-deterministic: if an agent is in state qᵢ∈Q with an input symbol σ∈Σ, the agent can choose the output symbol and next state among the set δ(qᵢ, σ):={(a, qⱼ)∈A×Q|δ(qᵢ, σ, a, qⱼ)=1}.

The input and output alphabets (Σ and A) of the FSA can be referred to as the condition set and action set, in which σ∈Σ and a∈A represent conditions and actions, respectively. The state machine's objective is to adjust the control input so that the system's state evolves in a way that accomplishes the task while simultaneously satisfying the pre-defined performance or constraint criteria.

Table 1 shows examples of transition rules, e.g., employed in the keyword handler function 230, defined for keywords under a specific grammar.

TABLE 1

| Category | Grammar | Transition Rule | Example |
|---|---|---|---|
| Default Transition | VP^{A} | 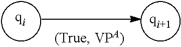 | [dial number] |
| Direct Transition | VP^{A} [j] | 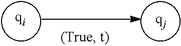 | [proceed] [1] |
| Conditional Transition | if VP^{C}, VP^{A} VP^{A} if VP^{C} | 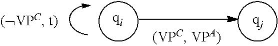 | [if] [no car], [cross] |
| Conditional Transition (if else) | if VP^{C}, VP^{A}₁ if ¬ VP^{C}, VP^{A}₂ | 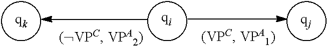 | [if] [no car], [cross]. [if], [car] [stay]. |
| Self Transition | wait VP^{C} VP^{A} VP^{A} after VP^{C} | 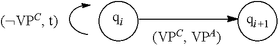 | [wait] [car pass] [cross] |
| | VP^{A} until VP^{C} | 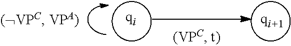 | [stay] [until] [car pass] |

Noun Phrase. Noun Phrase (NP) is a group of words headed by a noun. A Verb Phrase (VP) is composed of a verb and its arguments. VP follows the following grammar per Equation Set #1.

$$VP ← V VP \qquad ( Eq . Set 1 )$$

$$VP ← V NP$$

In Equation Set #1, the left-hand side of the grammar includes the components on the right-hand side. The grammar defines a verb phrase as being either composed of a verb and another verb phrase or composed of a verb and a noun phrase. To standardize the words under the phrase structure, the parsing operator can convert all the words to their original form, e.g., it removes singular or plural, past tense, etc. This operation eliminates cases where phrases with the same words in different tenses are categorized as being distinct.

Verb Phrase (VP^{A}, VP^{C}). Action verb phase VP^{A} is a verb phrase describing an action that the controller might take. Condition verb phrase VP^{C} is a verb phrase indicating the conditions for triggering the transitions in the FSA. For each verb phrase, the algorithm (e.g., Algorithm “2”) can classify the verb phrase as VP^{A} by default unless the grammar associated with the keywords specifies that it is a VP^{C}, as illustrated in Table 1.

If a verb phrase VP includes one or more of the words “and,” “or,” “no,” or “not,” then the algorithm can refer to the VP as a VP phrase, e.g., per Equation Set #2.

$$no / not {VP}_{1} = - {VP}_{1} \qquad ( Eq . Set 2 )$$

$${VP}_{1} and {VP}_{2} = {VP}_{1} ∧ {VP}_{2}$$

$${VP}_{1} or {VP}_{2} = {VP}_{1} ∨ {VP}_{2}$$

Default Transitions. In Table 1, default transition (272, FIG. 2C) is a transition operation from the current state in the state machine Q to the next state with the condition “True.” Each state qᵢ only has one outgoing transition to its next state qᵢ₊₁, with the verb phrases from the i^{th} step as the output symbols. A default transition δ(qᵢ, True, VPᵢ^{A}, qᵢ₊₁) exists unconditionally of the valuation of the atomic propositions in P (hence the corresponding transition's condition is True).

Direct State Transitions. Direct state transition (274) is a transition operation in the state machine Q from the current state qᵢ to a state other than the next state qᵢ₊₁. The direct state transition can occur when there is a verb phrase in the step description that contains the number corresponding to another step. The algorithm builds a direct state transition from the current state to the state representing step j with an output symbol ϵ (no operation).

Conditional Transitions. Conditional transition (276) is a transition operation that only occurs for a specific condition. During automaton construction, the algorithm can build a conditional transition 406 when a step description contains the keyword “if.” The conditions themselves are defined as one or more atomic propositions in P.

Table 1 shows two condition transitions (276a, 276b): a one-way transition and a two-way transition. The one-way transition 276a (similar to an if operator) includes a starting state qᵢ, a conjunction of atomic propositions VP^{C}, a target state qⱼ, and a set of outputs VP^{A}. If the VP^{A} does not lead to a direct state transition, then the transition will end at qᵢ₊₁. The two transition 276b (similar to an if-else operator) include a self-transition at qᵢ with a condition ¬VP^{C} and with an output symbol ϵ (no action).

Self-Transitions. Self-transition (278) has identical starting and target states. The algorithm can construct self-transitions when a step description contains any of the keywords “wait,” “after,” or “until.” The self-transition (278) causes the automaton to stay in the current state until a logical condition is met, as specified by the keywords. The keywords and surrounding verb phrases are used to define the conditional transition that breaks the self-transition loop and proceeds to the next state.

### Example Finite State Automaton

FIG. 2C shows an example FSA 280. In FIG. 2C, transitions 282 are labeled with tuples (φ, a), where φ is a logic formula with atomic propositions in P, and a is an output symbol in A. In FIG. 2C, the transition from state q₀ to state q₁ happens unconditionally (always TRUE) with the output symbol a₁. At state q₁, the FSA can either choose output symbol a₂ or empty symbol (ϵ), as long as the corresponding conditions (p and p∨q, respectively) hold true.

The state machine of a controller is a system component responsible for making decisions and taking actions based on the system's state. A finite state automaton or finite state machine can be mathematically represented as a mapping from the system's current state to an action, which is executable in the task environment. Here, the exemplary FSA output can be directly or indirectly employed as a finite state machine.

### Example Model Checking Module and Refinement Module

The controller generation engine 104 can verify, via a model checking module 156, if a generated finite state automaton meets pre-defined requirements, e.g., logical accuracy specification, safety specification, performance specification, and intent specification of the user. The refinement module 158 can further modify the FSA using the verification outcomes to meet the pre-defined requirements. FIG. 2E shows an example method to perform module checking. As shown in FIG. 2E, the module checking can check the specification against all potential system executions.

Modeling Checking Module. The model checking operator 156 can verify (e.g., 124) that a controller [symbol] (as the FSA) satisfies the specification Φ given the model [symbol] per Equation 3.

$$⊗ \vert = Φ \qquad ( Eq . 3 )$$

In Equation 3, [symbol] ⊕ [symbol] denotes a product automaton describing the interactions of the controller [symbol] with the model [symbol] . The controller's state machine [symbol] output by GLM2FSA can be defined as [symbol] := [symbol] Σ, A, Q, q₀, δ [symbol] having an input alphabet Σ:=2^{P}, an output alphabet A:=2^{P}^{_{A}}, and non-deterministic transition function δ:Q×Σ×A×Q→{0, 1}.

The product automaton can be characterized as a transition system [symbol] = [symbol] ⊕ [symbol] := [symbol] [symbol] , [symbol] , [symbol] , [symbol] [symbol] with the components per Equation Set #4.

$$:= \times Q \qquad ( Eq . Set \#4 )$$

$$:= ( {p}_{0} , {q}_{0} )$$

$$( ( p , q ) ) := \{ ( {p}^{′} , {q}^{′} ) ∈ \vert δ ( q , ( p ) ⋂ \sum , a , {q}^{′} ) = 1 and ( p , a , {q}^{′} ) = 1 , for a ∈ A \}$$

$$( ( p , q ) , ( {p}^{′} , {q}^{′} ) := \{ ( p ) ⋃ a \vert a ∈ A and δ ( q , ( p ) ⋂ , a , {q}^{′} ) = 1 and ( p , a , {q}^{′} ) = 1 \}$$

In Equation Set #4, [symbol] : [symbol] →2 [symbol] is a non-deterministic transition function, and [symbol] : [symbol] × [symbol] →2^{P∪P}^{_{A}}^{∪{goal}} is a labeling function on the transitions of the product automaton. The product automaton can generate infinite trajectories (p₀, q₀), (p₁, q₁), . . . starting from an initial state [symbol] and following the nondeterministic transition function [symbol] thereafter. Labeled trajectories can then be generated by applying the labeling function [symbol] to these trajectories within the product automation, i.e., ψ₀ψ₁, . . . ∈(2^{P∪P}^{_{A}}^{∪{goal}})* where ψᵢ∈ [symbol] ((pᵢ, qᵢ, (pᵢ₊₁, qᵢ₊₁)). When using the product automaton to solve the model-checking problem from Equation 2, the model-checking operator 156 can check that all possible labeled trajectories generated by the product automaton belong to the language defined by the LTL specification.

Further descriptions of the automated verification problem are described in [4]. Such problems can be efficiently solved using widely available and highly-optimized software libraries, e.g., the NuSMV model checker [7].

### Example Method of Operation for Example Task (“Cross the Road”)

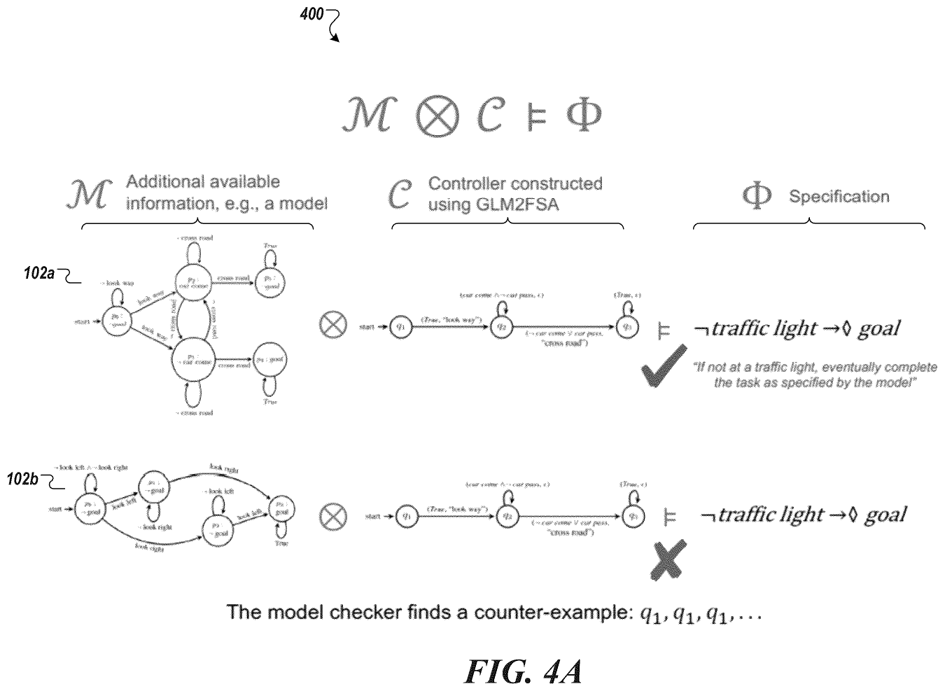

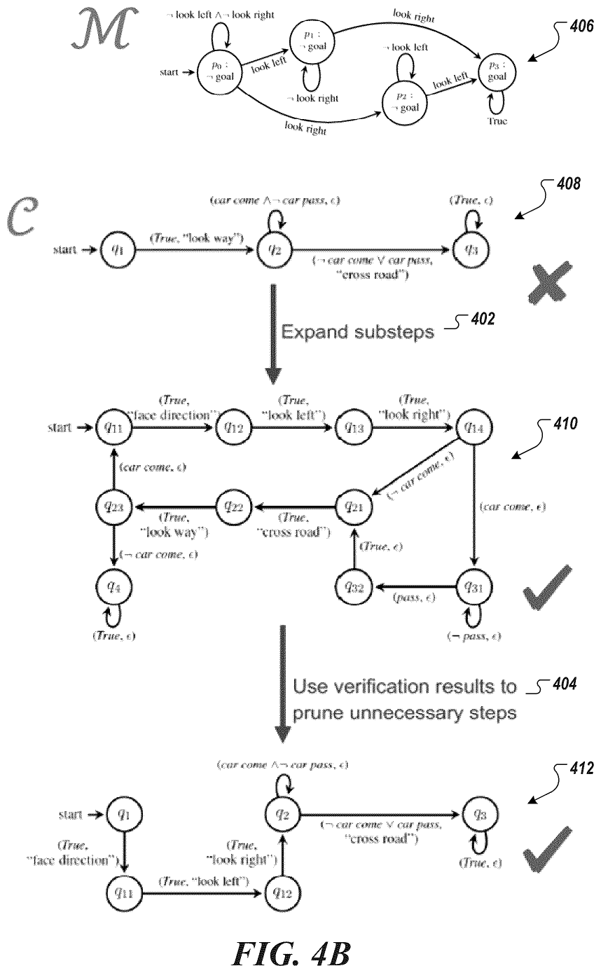

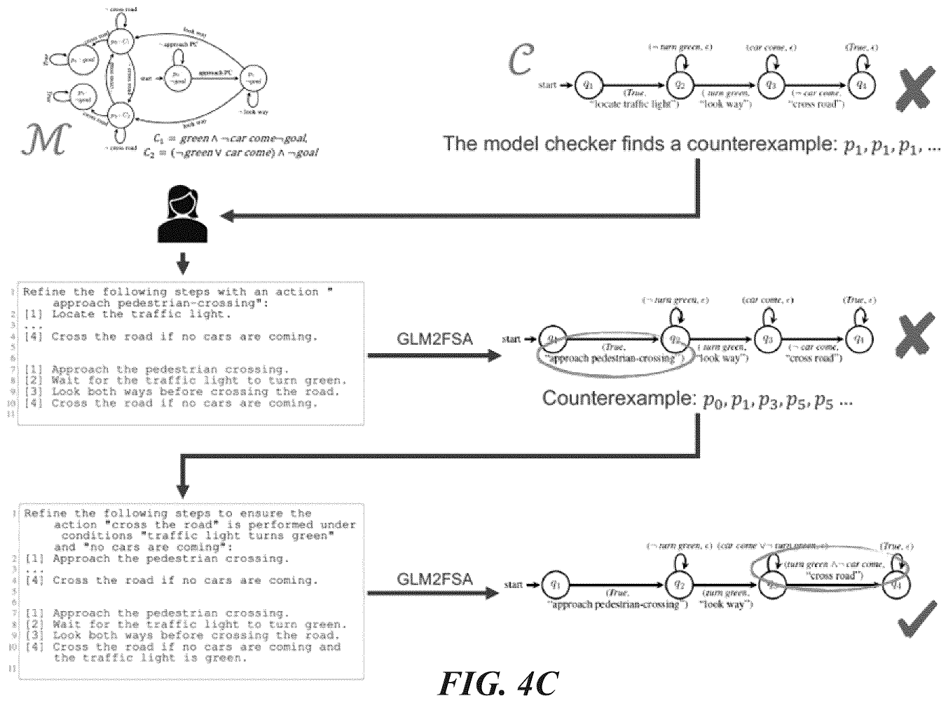

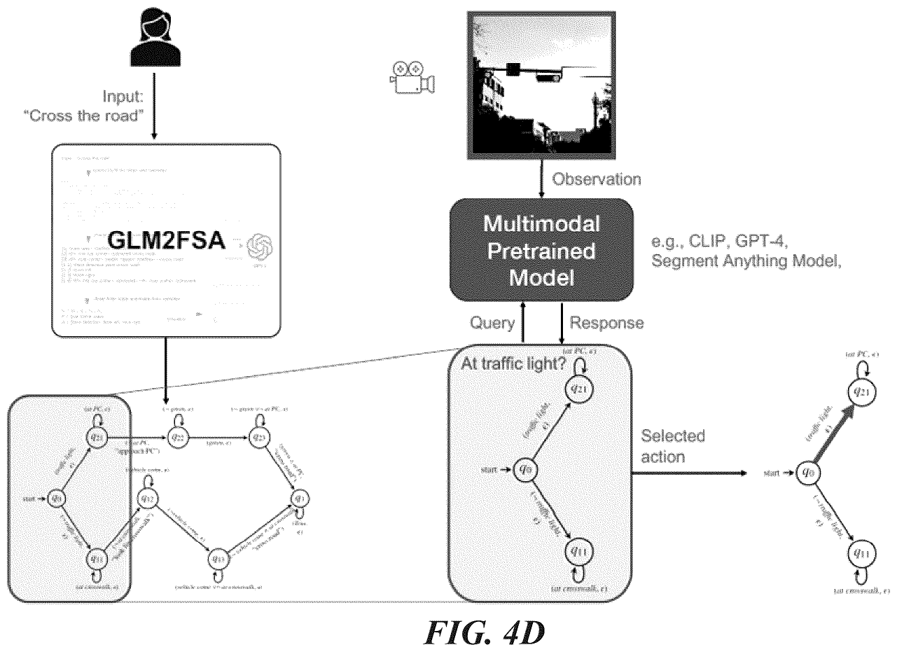

FIGS. 3A-3F shows an example method 300 to construct a finite state automaton for an example task “Cross the road.” FIGS. 4A-4C shows an example operation to verify and modify the finite state automaton for the example task “Cross the road.”

Query Construction. In FIG. 3A, Method 300 first queries (118) the GLM 105 for step descriptions of a task from the input “Cross the road’” 303 by generating, e.g., according to Algorithm “1” 200a of FIG. 2A, queries 302 containing the user provided task description (“Cross the road”) to the GLM (e.g., 105). The GLM responds (302) by returning a list (304) of text instructions for the steps 306 (shown as 306a, 306b, 306c). Method 300 then queries (still in 118) a list 308 of steps (e.g., 306a-306c) for substeps 310 (shown as 310a, 310b, 310c, 310d). Each of the step descriptions (306a-306c) and substeps description (310a-310d) includes a step label (312) and substep label (314).

FIG. 3B shows an example of a template of a prompt/conversation with GPT-3 using a Davinci-002 model. In FIG. 3B, the prompts sent to GPT-3 are illustrated in blue, and the corresponding completion of GPT-3 is shown in red. The prompts for substeps include the history of previously queried steps (prompt and completion).

Parsing and FSA construction. Method 300 then applies parsing operation (120), e.g., via the GLM-to-FSA module 154, e.g., per Algorithm “2” 230a, to parse each of the textual instructions (306a-310c, 310a-310d) into input and output symbols 318 (e.g., propositions P and actions A) of the FSA. In some embodiments, the parsing operation is based on semantic parsing, though in other embodiments, other parsing operators can be used. Method 300 then uses the input and output symbols 318 (e.g., propositions P and actions A) to construct (122) the automaton states Q and its outgoing transitions. The resulting FSAs can be employed as a state machine for a controller that can perform sequential decision-making of the requested task 303. FIG. 3D shows an example FSA generated from the Algorithm “2” 230a in the context of the example requested task of “crossing the road.”

FIG. 3E shows the GLM-to-FSA module automatically generating meaningful atomic propositions A and action descriptions A that were not included in the original prompt from steps and substeps that are returned from the GLM based on the query (118). The returned GLM output can be parsed to provide a set of atomic propositions: {car come, pass, . . . , turn green, traffic light} and a set of output symbols: {“look way,” “cross road,” . . . , “locate traffic light,” ϵ}.

FIG. 3F shows an example hierarchical expansion of controller substeps. In FIG. 3F, the set of output symbols: {“look way,” “face direction,” “cross road,” “look right,” “look left,” ϵ}.

Phrase Duplication Removal. Due to the stochastic nature of generative models, the GLM may often output different description phrases to represent the same concept. Furthermore, the verb phrases used to define the symbols of the externally provided model may use a different vocabulary than the one that was generated by the GLM. This mismatch in verb phrases could lead to multiple distinct verb phrases being used to describe conditions and actions that we intuitively understand as being the same. As a result, the automated verification procedure may yield unexpected failures because of its inability to recognize synonyms.

To remove the ambiguities, for every pair of verb phrases, the GLM-to-FSA module 154 can query the GLM and ask it if the phrases have the same meaning. More specifically, the GLM-to-FSA module 154 can use an input prompt in the format per FIG. 3C for all pairs of verb phrases. If the GLM responds that two distinct verb phrases have the same meaning, the GLM-to-FSA module 154 can consolidate the phrases, e.g., by keeping one of the phrases in the set of symbols and replacing all instances of the other phrase.

FSA Verification. FIG. 4A shows verification operation 400 performed, e.g., via the model checking module 156, on the constructed FSAs (shown as 102a, 102b) to be verified against user-defined specifications Φ (160) an external model [symbol] (162) per Equation 3. The FSA 102a is shown to meet the provided requirement. FSA 102b is shown to fail the provided requirement in which the model checker, e.g., finds a counter-example: q₁, q₁, q₁, . . .

The model checking operator 156 can operate on the automaton-based controller [symbol] outputted by the GLM-to-FSA module 154. The model checking operator 156 can use a model [symbol] to verify the behavior of the controller [symbol] against task specifications of interest Φ. A task specification is a temporal logic formula, e.g., Φ=□car come→¬cross road (never cross the road when a car is coming). If the controller [symbol] fails to satisfy the task specification Φ, the refinement operation (per module 158) can be executed to expand the FSA's steps with additional substeps and/or prune substeps that do not lead to a change in the result of the model checking operation.

An example of a model checker employed in the model checking module 156 is NuSMV as described in [7]. If the output of the model checking module 156 indicates the FSA 102 passes the check, then the FSA 102 can be outputted as the controller (e.g., 106). When the output indicates the check failed, the FSA refinement module 158 can be invoked to modify the FSA.

Automated Refinement Through Substep Expansions. The FSA refinement module 158 can automatically refine the steps and substeps of the generated controller [symbol] (106′) by querying the GLM (e.g., 105) for additional steps or substeps. The controller generation engine 104 can then evaluate the updated controller [symbol] ′ in a continuing iterative operation until the successful evaluation is met while using information derived during the verification operation.

FIG. 4B shows an example of an automated refinement operation, e.g., performed by the FSA refinement module 158, through substep expansions. During the refinement step, the FSA refinement module 158 can re-execute Algorithm “1” to query the GLM for a next-layer step (DEPTH=DEPTH+1). The FSA refinement operation 158 can then expand (402), via Algorithm “2,” each of the automaton's transitions into more detailed representations describing additional substeps.

The FSA refinement module 158 can determine a state that is the beginning of the transition to be expanded and define it as the parent state and the states that represent that transition's substeps as the child states. The FSA refinement module 158 can continue the loop of expanding the automaton's transitions and execute the automated verification (e.g., 156) until all the specifications Φ are satisfied or the maximum number of layers is reached. The maximum number of layers can be a user-defined constant. If the refinement operation 158 added a maximum number of layers and the model [symbol] still does not satisfy the specifications Φ, the FSA refinement module 158 could output a notification to the user that the task is not tenable for the reasons that it had failed.

To keep the iterative refinement procedure from generating unnecessarily large automaton-based controllers, the FSA refinement module 158 can also use the verification results to prune (404) unnecessary states. It is unlikely that all of the automata's steps need to be further refined with additional substeps to satisfy the task specifications. The pruning process can include: (i) start from the deepest-layer steps and replace the first set of children states with their parent state, (ii) check if the controller still satisfies all the specifications, (iii) maintain the controller [symbol] as it is if the specifications Φ are satisfied, otherwise add the children states back, and iv) continue steps i to iii for all of the children states at each level of the hierarchy.

Model checking module 156 can operate a model [symbol] that represents priori task-related knowledge provided by the user (e.g., 112) and GLM (e.g., 105). The model checking module 156 can check if the controller [symbol] is consistent with the existing knowledge or if it will satisfy logical-based specifications when implemented against the model. Such systematic verification is beneficial to identify and guard against undesirable or nonsensical outputs from the GLM and to identify missing states for given additional requirements.

Mathematically, the model [symbol] can be defined as a transition system, e.g., [symbol] := [symbol] [symbol] , [symbol] , [symbol] , p₀, [symbol] , [symbol] [symbol] in which [symbol] :=A=2^{P}^{_{A}} is a set of input symbols for the model; P_{A} is a set of atomic propositions representing actions in the controller; [symbol] :=2^{{goal}∪P} is a set of output symbols; P is the set propositions from [symbol] and goal is a special additional proposition; [symbol] is a finite set of states; [symbol] : [symbol] × [symbol] × [symbol] →{0, 1} is a non-deterministic transition function; p₀∈ [symbol] is an initial state. and [symbol] : [symbol] → [symbol] is a labeling function.

Model checking module 156 can be used on a linear temporal logic (LTL) [4] that defines task specifications Φ that the controller [symbol] should satisfy, given the model [symbol] . LTL is a formal language that expresses system properties that evolve over time. It extends propositional logic by including temporal operators—⋄ (“eventually”) and □ (“always”)—which allow for reasoning about the system's future behavior.

Model checking module 156 can define specifications Φ over atomic propositions in P∪P_{A}∪{goal}, and evaluate them over trajectories in the form (2^{P∪P}^{_{A}}^{∪{goal}})*. In the context of the verification problem, specifications Φ represent desired outcomes that the controller should satisfy, given some assumptions on the properties of the system that the controller interacts with.

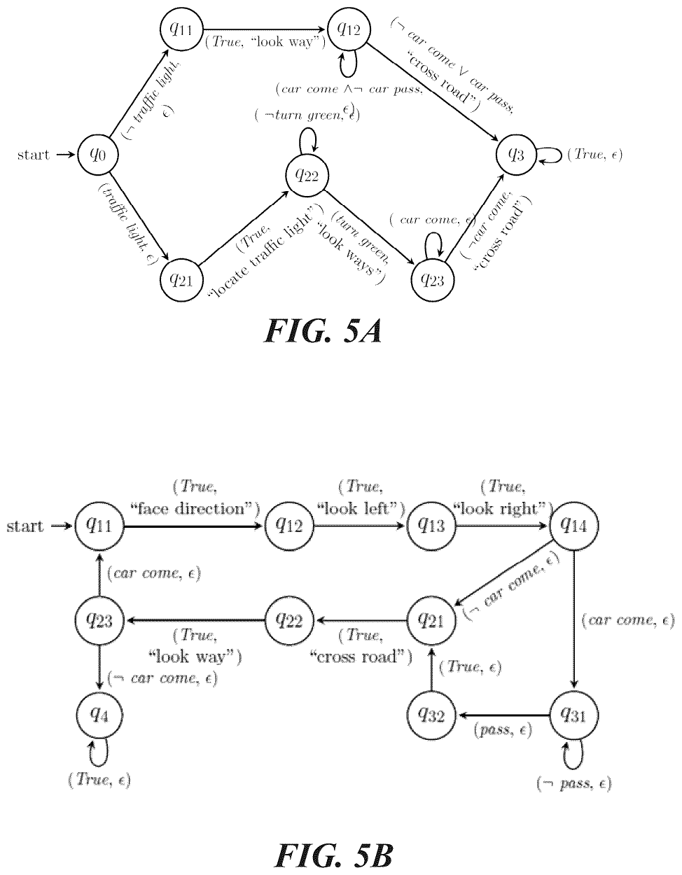

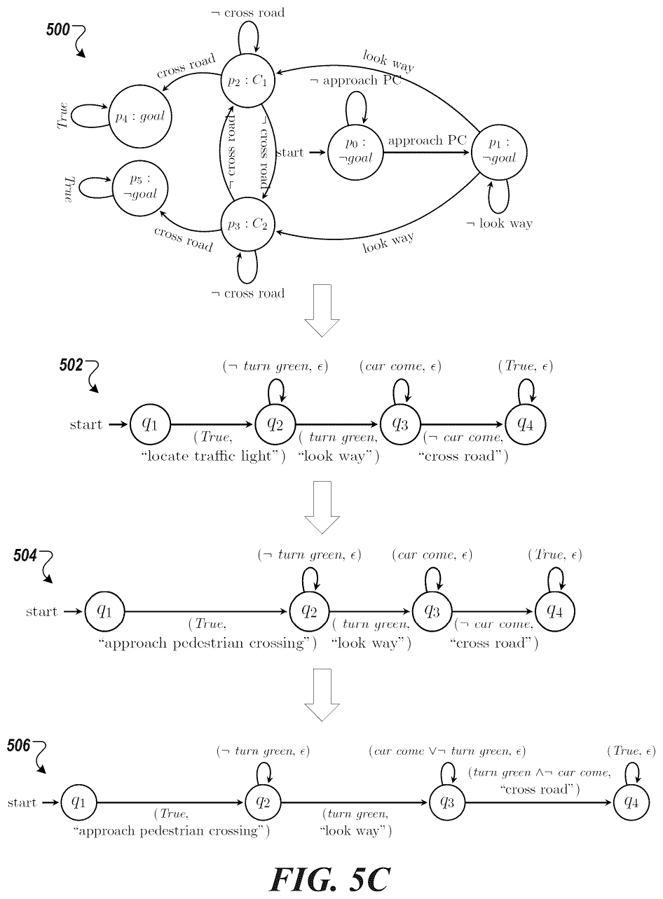

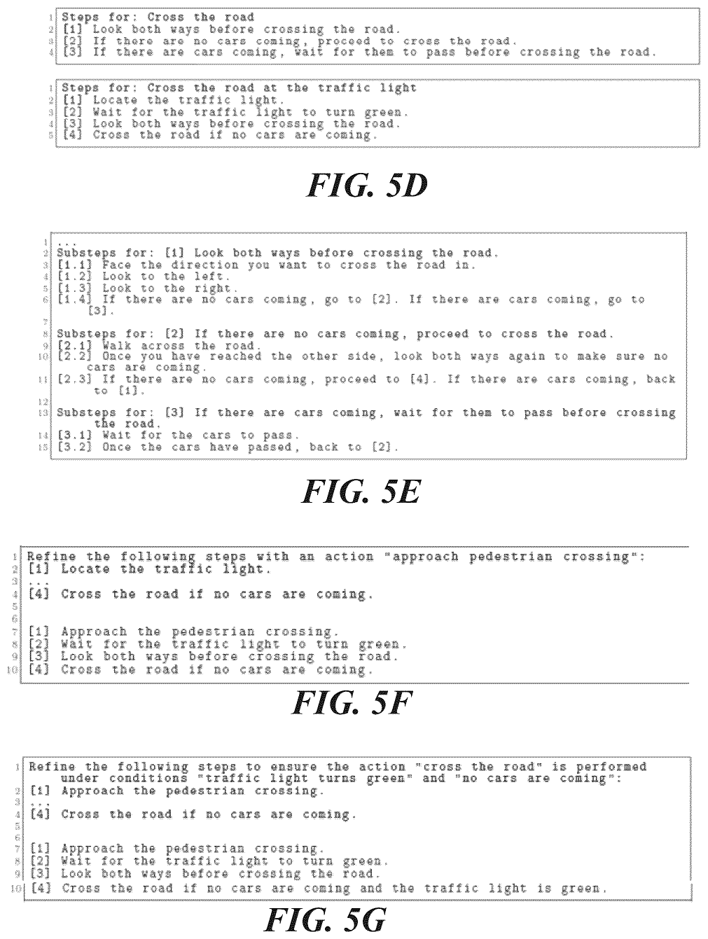

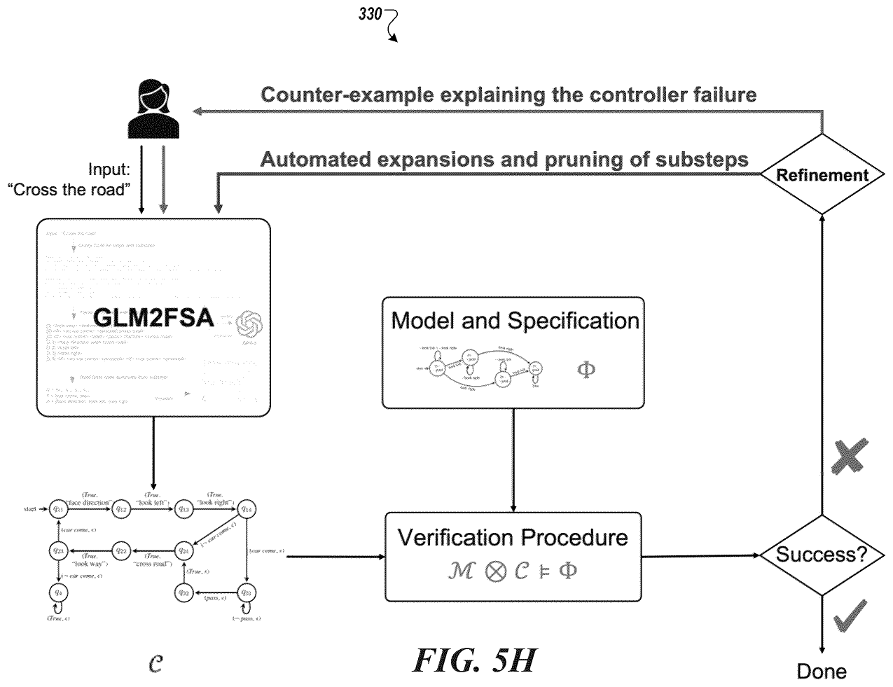

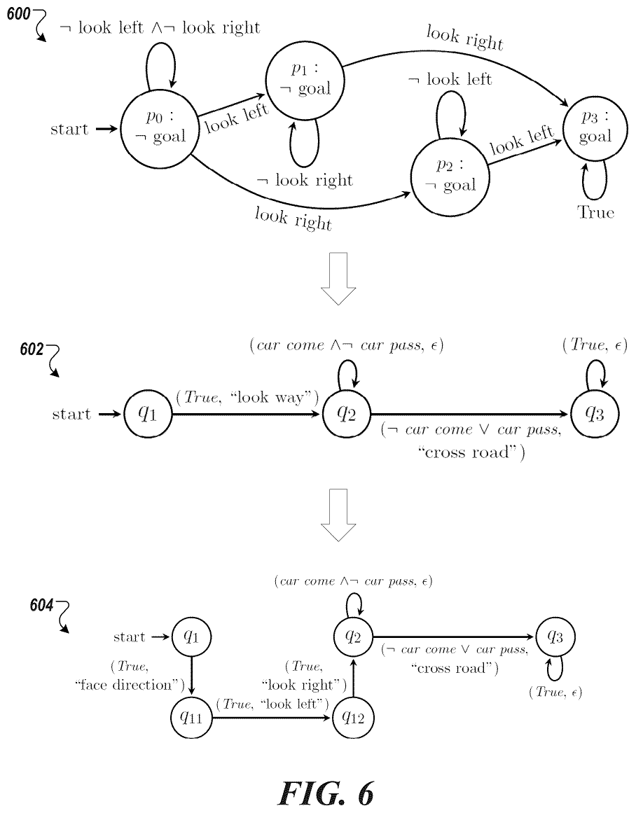

Further details are provided in relation to FIGS. 5A-5F and FIG. 6. An example application of the model checker module to verify the behavior of an example controller against a user-specified model and specification is provided in Appendix A, which is incorporated by reference herein.

FSA Refinement Through GLM Refinement. In another embodiment, the FSA refinement module 158 can refine the steps and substeps of a prior-generated controller [symbol] by generating a new controller [symbol] ′ based on counter-examples determined from the verification process. To this end, the counter-examples can be translated into prompts to be included as a part of the GLM query. FIG. 4C shows an example operation. Further details are provided in relation to FIGS. 5A-5F.

FSA Refinement through Machine Learning. FIG. 4D shows an FSA refinement module (e.g., 156) employing a multi-modal, pre-trained machine learning models configured to perform verifiable sequential decision-making.

### Example Finite State Automaton Generation, Verification, and Refinement

“Cross the Road” Task State Machine Generation. FIGS. 5A-5F and FIG. 6 show an example controller generation and verification/refinement for the task command “cross the road.” FIG. 5A shows an initially generated FSA for this scenario performed in a study. The study first applied algorithm “1” to construct an FSA for first-layer step descriptions. The study queried the GLM for two distinct scenarios: (i) crossing the road at a traffic light and (ii) crossing the road when there is no traffic light, which is embodied in a single-state machine. FIG. 5A shows the GLS-to-FSA module 154 is capable of building unambiguous automaton-based representations of task-relevant knowledge in a first-layer step description. FIG. 5D shows the query for the queries used to generate the first-layer description. As shown in FIG. 5A, the constructed FSA includes all the required knowledge—including the task-relevant actions and conditions—under the two different operating scenarios in which the traffic light either exists or does not exist. The task steps are represented by states q₀, q₁₁, q₁₂, q₂₁, q₂₂, q₂₃, and q₃. The algorithm “1” automatically generated the set of atomic propositions P={“car come,” “car pass,” “turn green,” “traffic light”} and the output symbols A={“look way,” “cross road,” “locate traffic light,” and ϵ} from the extracted verb phrases.

FIG. 5B shows the constructed FSA for the second-layer descriptions. FIG. 5E shows the query for the queries used to generate the second-layer description. The study executed algorithm “1” to continue querying for the substeps of each step of the first layer description. The study referred to the substep descriptions returned from GPT-3 as the second-layer step descriptions. To simplify the discussion, only the second-layer descriptions for the scenario where no traffic light exists are now discussed.

As shown in FIG. 5B, the FSA included states representing each substep, a set of atomic propositions P={car come, pass}, output symbols A={“look way,” “cross road,” “face direction,” “look left,” “look right,” ϵ}, an initial state q₁₁, and a final state q₄. FIG. 5B demonstrates the ability of GLM2FSA to construct FSAs that represent more detailed task descriptions.

It can be observed in FIG. 5B that a portion of the automaton does not agree with what would be intuitively expected for the task description “cross the road.” Specifically, it would be expected that the action “cross road” would lead the FSM from state q₂₁ directly to the goal state q₄. That is, when the agent crosses the road and no car is coming, the task should be complete. Instead, the automaton transitions from q₂₁ to q₂₂ to check if a car is coming and potentially crosses the road a second time. The disagreement illustrates a shortcoming of the use of large language models in an autonomous system. To address unexpected or nonsensical instructions for a requested task, the study determined that a method to formally verify and refine the outputs of the language model are beneficial for an autonomous system.

Automatic Refinement Through Query Refinement. FIG. 5C shows an example generated model (diagram 500) and subsequent iterations of the query refinements (diagrams 502, 504, 506) involving three iterations. In the example, the verification step is performed against the specification Φ:

Φ=traffic light∧□⋄(green∧¬car come)→⋄goal
[“if the agent is at a traffic light and there always will eventually be a time when the traffic light is green and no car is coming, then it should eventually reach the goal”]

In diagram 500, the model checker (e.g., 156) returns a counterexample that included an infinite loop of effectively states p₀, p₀, . . . , in which p₀ is the initial state of the model (specifically, states (p₀, q₁), (p₀, q₂), (p₀, q₃), (p₀, q₃), . . . , from the product automaton). The trajectory of the infinite loop included the controller input symbol [¬approach pedestrian crossing] and output symbol [¬goal], repeated indefinitely. In other words, the counterexample, as generated by the model-checking procedure, indicates the controller fails because the controller never takes the action “approach pedestrian crossing” required by the model. Indeed, the model checking (e.g., 156) determines an action is missing.

Diagram 502 shows the first iteration of the refinement of the controller. The first iteration includes the same controller of diagram 500 with the inclusion of the missing action (i.e., q₂). The input prompt to the GLM can be adjusted per FIG. 5F.

Diagram 504 shows a second iteration of the refinement of the controller. The refined controller appears correct with respect to the task and specification. It specifies that the agent should approach the pedestrian crossing, wait for the light to turn green, look both ways, wait for all cars to stop coming through the intersection, and cross the road. However, the refined controller fails the verification step with a counterexample p0→p1→p3→[infinite loop p5]. State p₅ in [symbol] is reached because it is possible for the controller to take action “cross road” when the traffic light is red. This mistake could happen in scenarios where the traffic light switches from green to red while the agent is waiting for cars to stop coming. This is a potentially dangerous edge case that the GLM did not consider. This edge case could be missed by a person as well. It is only by formally verifying the possible behaviors of the system against the model that the potential problem becomes apparent.

To handle the above corner case, the refinement module (e.g., 158) can ensure that the traffic light is green and that there are simultaneously no cars coming before taking action “cross road.” To address the issue in diagram 502, the input prompt to the GLM can be adjusted per FIG. 5G.

Diagram 506 shows a third, final iteration of the refinement of the controller. In the third iteration, the controller passes all the verification steps, and hence it is finalized.

Automatic Refinement Through State Expansion and Pruning. FIG. 6 shows an example generated model (diagram 600) and subsequent iterations of the refinements (diagrams 602, 604, 606) involving two iterations.

The verification step is performed against the specification Φ:

Φ=¬traffic light→⋄goal [“if the agent is not at a traffic light then it should eventually reach the goal”]

Under this model, FSA 406 fails to satisfy the specification. The FSA refinement module (e.g., 158) can query the GLM for second-layer steps (substeps of the first-layer steps) (408) to which a new controller 410 can be constructed that further includes the second-layer steps. The GLM-to-FSA module can additionally prune extra states and transition. The resulting FSA 412 is the final controller that now passes the specification Φ. Because the pruned controller 412 satisfies the specification shown in FIG. 4A, the refinement procedure terminates and no further queries to the GLM are needed. Furthermore, because the unnecessary steps had been pruned, the new controller also resolves the logical flaw raised in our first examination of the example.

### Experimental Results and Additional Examples

A study was conducted to develop a proof-of-concept system that can automatically construct automaton-based representations of abstract task knowledge from GLMs. The study developed an algorithm referred to as the GLM2FSA that accepts brief natural-language descriptions of tasks as input, queries a GLM, and then constructs an automaton from the language model's responses. The algorithm was highly automated, requiring only a short task description to build machine-understandable knowledge representations. The study developed methods to formally verify the automata output by the GLM2FSA and to use the results of verification to iteratively refine the inputs to the GLM. Experimental results demonstrate the capabilities of GLM2FSA. The generated automaton-based controllers capture domain-specific knowledge, even when applied to highly specialized problems. Furthermore, the procedure for verification-guided controller refinement can automatically catch, explain, and fix the occasional nonsensical or incorrect behaviors that are output by the GLM.

The study implemented the various algorithms in Python. GLM2FSA is the first algorithm that can construct automaton-based representations from large-scale GLMs' textual knowledge to verify the knowledge from GLMs in the context of sequential decision-making and to use the results of the verification procedure to refine the extracted FSAs.

Example Demonstrations of Controller Construction. The study constructed several automaton-based controllers to demonstrate the capabilities of GLM2FSA, including (i) “cross the road” task, “book a dental appointment” task, and (iii) secure Multi-Party Computation. In the example, the study employed GLM2FSA to create FSAs that encode all of the knowledge required to describe the steps to complete a given task. In all of the following experimental case studies, the study used the text-davinci-003 model from the GPT-3 model family [6].

FIGS. 5A-5F and FIG. 6 show an example controller generation and verification/refinement for the task command “cross the road.”

### Additional Example Tasks #2, #3, #4, #5, #6

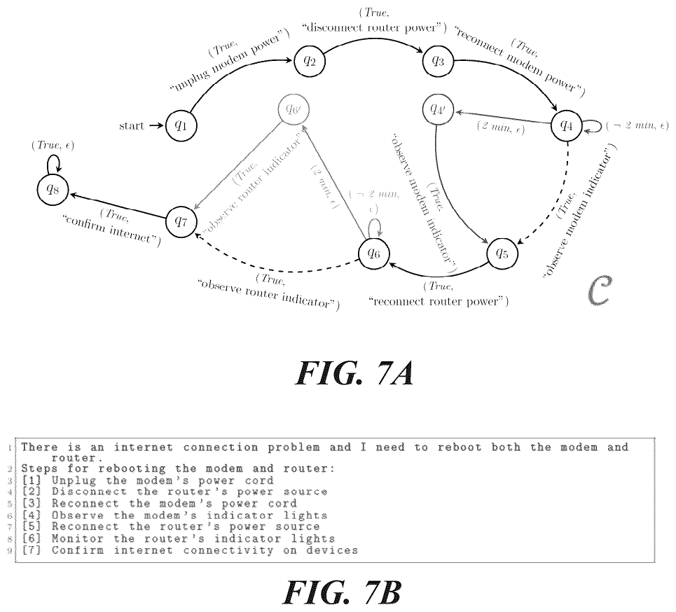

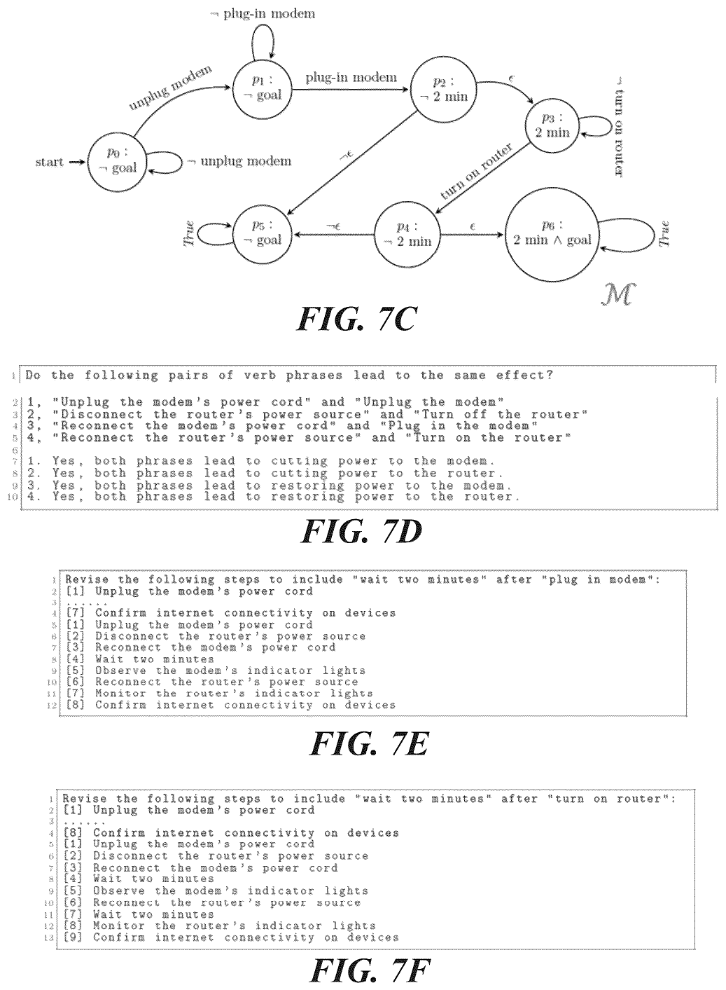

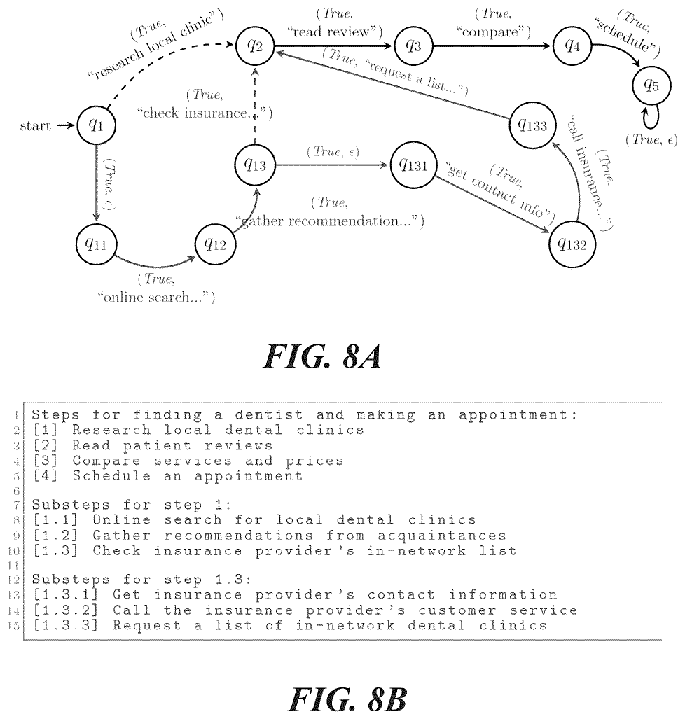

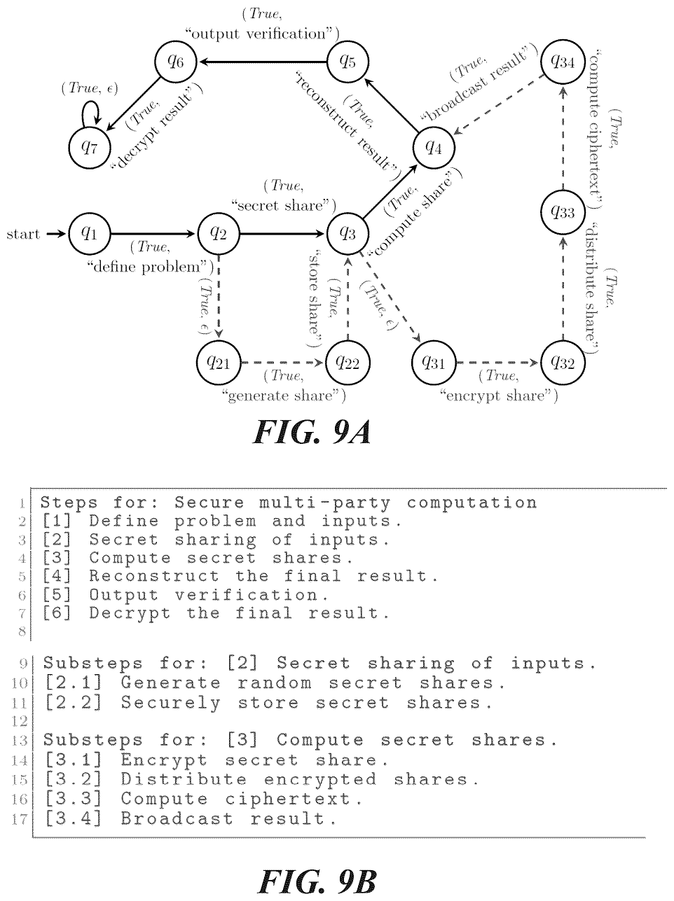

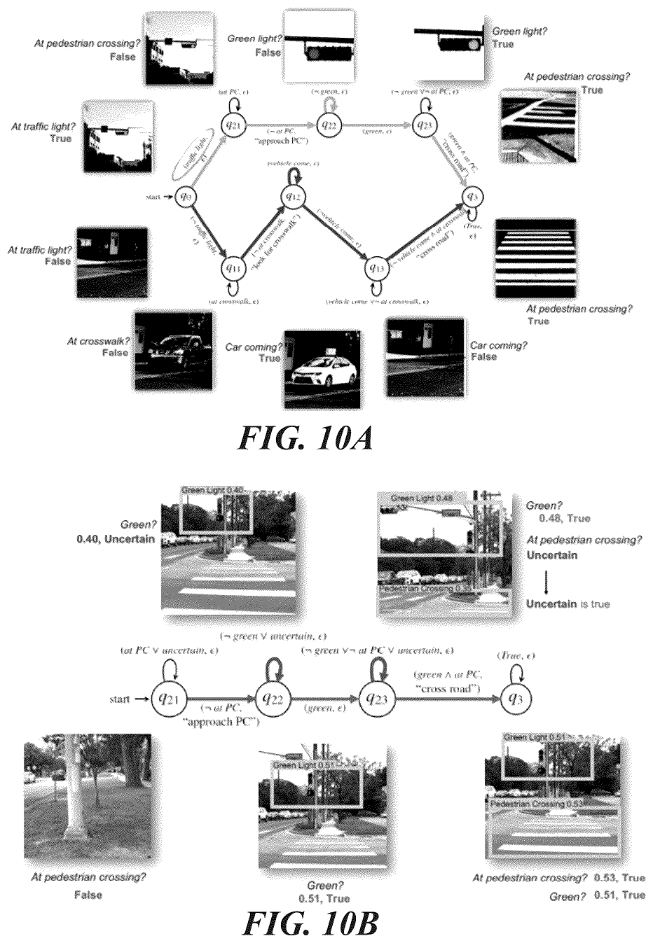

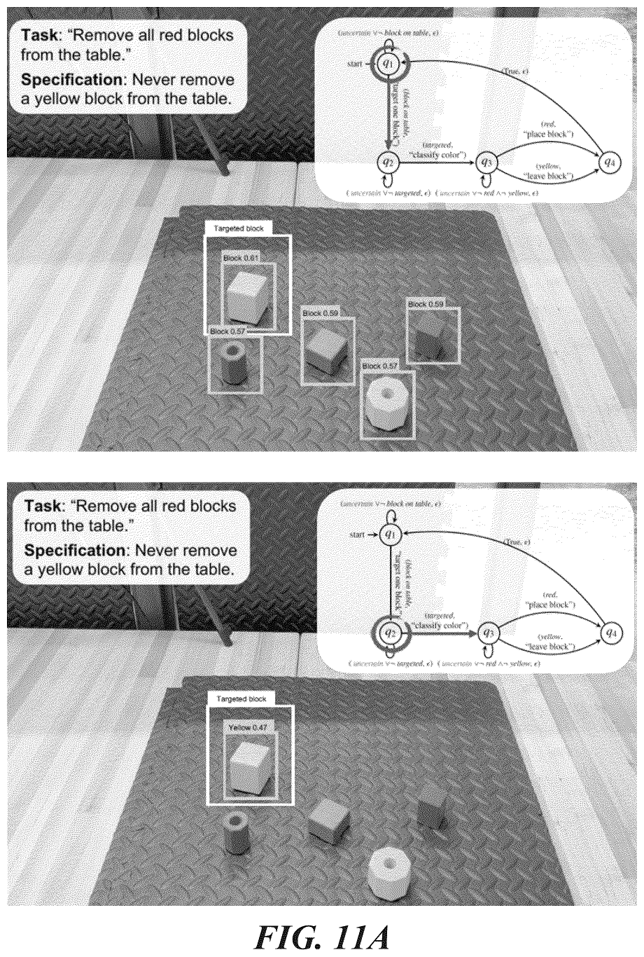

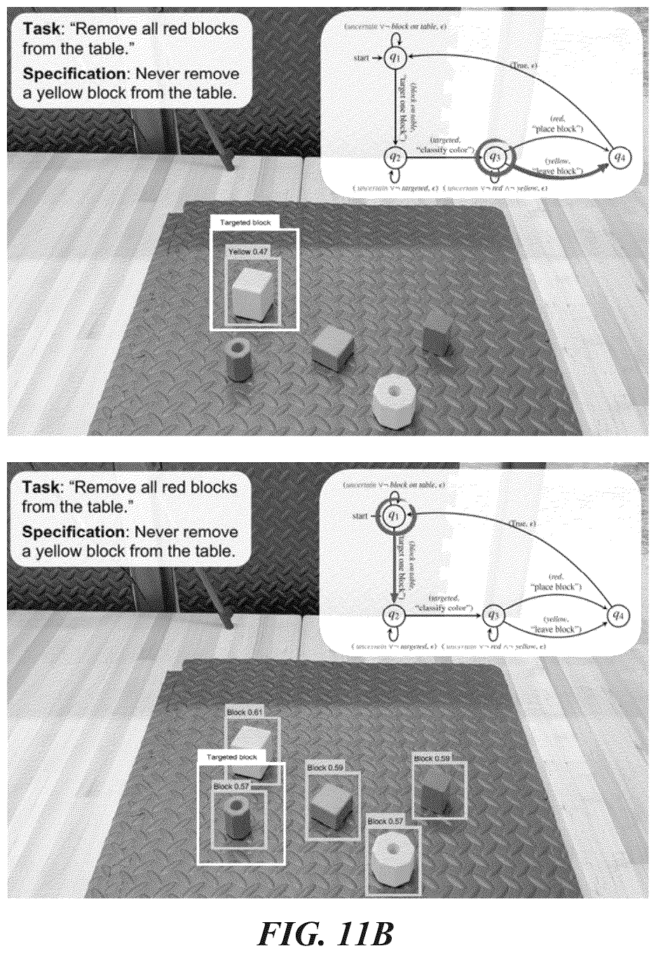

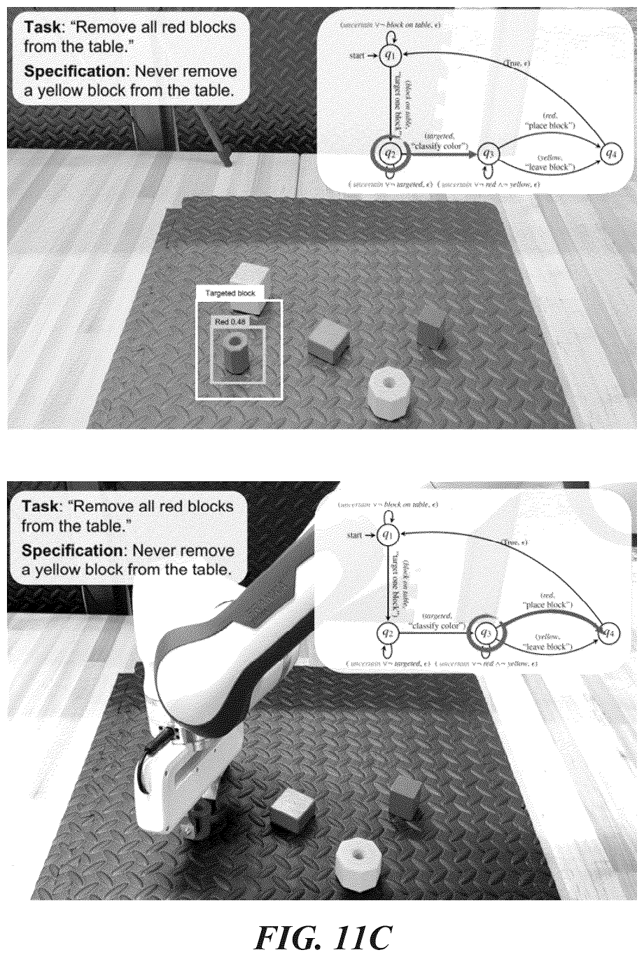

FIGS. 7A-7F show an example controller generation and verification/refinement for a task command associated with troubleshooting and debugging. FIG. 8A-8B show an example controller generation and verification/refinement for a task command associated with scheduling a task. FIG. 9A-9B show an example controller generation and verification/refinement for a task command associated with multi-party computation coordination. FIGS. 10A-10B show example controller generation for task command associated with vehicle control. FIGS. 11A-11C shows example controller generation for task command associated with robot controls.

Hardware Troubleshooting/Debugging. FIG. 7A shows a generated FSA for a second example task associated with troubleshooting and debugging for a hardware device. In FIG. 7A, the transitions in black were constructed using the initial GLM response. FIG. 7B shows the query for the queries used to generate the first-layer description. FIG. 7C shows a model that encodes information about the rebooting of the model and router.

Because the controller and model encode knowledge from different sources using different phrases or terminology, the controller generation engine 104 matches the verb phrases from the controller and model before proceeding with the verification procedure. FIG. 7D show an example prompts to GLM for a phrase duplication removal operation.

With the synonymous verb phrases consolidated, the model checking operator (e.g., 156) verified the controller satisfies the specification Φ=⋄goal when implemented against the model. In the first iteration, the verification failed and the model checker returned a counterexample of states p₀→p₁→p₂→[infinite loop p₅]. The failure occurred because the initial controller generated by GLM2FSA does not wait for any amount of time before restarting the modem, however, the model per FIG. 7C requires a waiting period. FIG. 7E shows input prompt to the GLM to refine the controller.

In the second iteration, the model checking operator (e.g., 156) ran the model checker again on the refined controller and returned another counterexample p0→p1→p2→p3→p4→[infinite loop p5]. FIG. 7F shows revised input prompt to the GLM to refine the final controller.

Appointment scheduling. FIG. 8A shows a generated FSA for a second example task associated with appointment scheduling. FIG. 8B shows the query for the queries used to generate the first-layer and second-layer descriptions.

Multi-party computation coordination. FIG. 9A shows a generated FSA for a second example task associated with multi-party computation coordination. FIG. 9B shows the query for the queries used to generate the first-layer and second-layer descriptions. The example demonstrates the application of GLM2FSA to fields where domain-specific expertise would be required. In this example, parties can jointly compute a function over their inputs while keeping those inputs private.

Vehicle Control. FIGS. 10A-10B show a generated FSA for a third example task associated with vehicle control. FIG. 10A show multimodal models of observations and atomic propositions being connected to vehicle camera inputs. FIG. 10B shows decision task for the vehicle at an intersection.

Robot Control. FIGS. 11A-11C show a generated FSA for a fourth example task associated with robot control. In each of FIGS. 11A-11C, the generated FSA and associated state is shown for a given robot action.

### Discussion

Automaton-based representations of high-level task knowledge can play a role in planning and learning in sequential decision-making. Such knowledge may include the requirements a designer wants to enforce on an agent, or a priori task information about the agent and the environment in which it operates. Automaton-based representations are useful in many applications, such as lexical analysis of compilers [5], [9], [33], [39] and program verification [34].

Despite their utility in a range of applications, capturing high-level task knowledge in automata is not straightforward. Automaton learning algorithms infer such knowledge through queries to a human expert or an automated oracle [23]. In general, these algorithms may require an excessive number of queries to a human, and it is often unclear how an automated oracle can be constructed in the first place. Even in cases in which an oracle exists, either the learning algorithm or the oracle requires prior information, such as the set of possible actions available to the agent and the set of environmental responses, i.e., symbols relevant for the automaton construction. It is often unclear how to obtain this information. Furthermore, the soundness of the inferred automaton depends on the choice of symbols.

Recent advances in large-scale generative language models (GLMs) can help automatically distill high-level task knowledge into automaton-based representations. Existing GLMs, such as the Generative Pre-trained Transformer (GPT) series [6], are capable of generating realistic, human-like text in response to queries. Such text often encodes rich world knowledge. But, the outputs of GLMs are still in a textual form that cannot be directly utilized for sequential decision-making or automaton learning, nor formally verifiable against user requirements, and so they cannot be used directly in safety-critical applications where correctness matters.

The exemplary system and method can fill the gap between the outputs from GLMs and automaton-based representations of high-level task knowledge. In particular, the exemplary system and method can produce controller as finite state automata (FSAs) from a brief natural-language sentence describing the task received from a user. The FSA-based controllers outputted by exemplary system and method are formally verifiable against user-defined task specifications. The results of the verification, e.g., counterexamples, can be used as feedback to iteratively refine them through additional queries to the GLM. Such systematic verification allows the algorithm to identify and guard against potentially undesirable or nonsensical outputs from the language model, making it a necessary step towards the safe integration of GLMs into automated decision-making systems.

Extracting Task Knowledge from Language Models. Extraction of task knowledge from language models has been studied in [8], [26], [38]. However, due to a lack of rich world knowledge, the language models used cannot generate action plans without providing detailed task descriptions. Recently, large generative models for text have been developed—in particular, the GPT series of GLMs—that contain rich world knowledge and that can generate instructions for a given task [10], [13]. Therefore, some works extract task-relevant knowledge by asking a GLM for step-by-step instructions to solve a particular task of interest [15], [37].

Recent works have studied how recent advancements in the capabilities of GLMs can be used to extract task-relevant semantic knowledge and to generate plans for task completion in the context of robotics [15], [16], [19], [30], [36]. In contrast to existing works, the instant study used GLMs to transform natural-language task descriptions into automaton-based representations that can be directly used for sequential decision-making and that can be formally verified against user-defined specifications.

Symbolic Knowledge Representations. Many works focus on constructing symbolic representations of task knowledge from natural language (text) descriptions. Several works extracted information from text descriptions of given tasks and use that information to construct task-relevant knowledge graphs [12], [28], [37]. Meanwhile, [22] analyzed the causality within the textual descriptions and creates causal graphs. [31] developed a semantic parser to map words to semantic forms, in order to help robots understand human dialog. [35] built logic-based representations of the solutions to planning tasks in order to explain why a particular plan is optimal. In contrast with the existing works, we take advantage of the generative capabilities of GLMs to automatically generate automaton-based representations from brief (one-sentence) textual task descriptions. Furthermore, the automaton-based representations we produce are directly applicable in algorithms for sequential decision-making and reinforcement learning [39], [17], [24], [25].

Existing works introduced approaches to transform natural language to formal language specifications [4], [11], [29], [32]. The reference [20] induced transformation rules that map natural-language sentences into a formal query or command language. [15] constructed a form of actionable knowledge that machines can recognize and operate on. However, existing works either cannot operate sequentially or cannot handle conditional transitions, e.g., multiple transitions from one state.

Automaton-based representation. Automaton-based representation is an abstract mathematical representation that represents the behaviors of a system. Automaton-based representations of high-level task knowledge can be used in planning and learning in sequential decision-making. They are useful in many applications, such as lexical analysis of compilers, reinforcement learning, and program verification. However, existing methods for capturing high-level task knowledge in automata are not straightforward. They infer such knowledge through an excessive number of queries to a human expert or an automated oracle, and it is often unclear how an automated oracle can be constructed in the first place. Even in cases in which an oracle exists, either the learning algorithm or the oracle requires prior information, which is often unclear how to obtain.

The recent advances in large-scale generative language models can help automatically distill high-level task knowledge into automaton-based representations. The outputs of those language models often encode rich world knowledge. On the other hand, these outputs are typically in a textual form that cannot be directly utilized for sequential decision-making or automaton learning. Moreover, the textual outputs are not formally verifiable against user requirements, so they cannot be used directly in safety-critical applications where correctness matters.

From the automaton learning perspective, current technologies for automaton learning require an excessive number of queries to a human, and it is often unclear how an automated oracle can be constructed in the first place. Even in cases in which an oracle exists, either the learning algorithm or the oracle requires prior information, such as the set of possible actions available to the agent and the set of environmental responses, i.e., symbols relevant for the automaton construction.

It is often unclear how to obtain this information. The method we invented takes advantage of the rich world knowledge encoded in large language models such as the GPT series. This method directly extracts task knowledge from the language model, which avoids the excessive number of queries to a human or an automated oracle and does not require any prior information. From the sequential decision-making perspective, current technologies utilize the knowledge from language models for decision-making or planning. However, their technologies have no guarantee whether the knowledge they obtained from the language model is precisely what the user expects.

In contrast, the exemplary system and method construct automata-based representations encoding the knowledge from language models. Such representations are formally verified against other sources of knowledge or user-provided specifications. Additionally, the exemplary system and method employ refinement procedure to guarantee the knowledge obtained will eventually satisfy the user's expectations or requirements, among other pre-defined requirements.

### Example Computing System

It should be appreciated that the logical operations described above for the homomorphically encrypted system can be implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, acts, or modules. These operations, acts, and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

The computer system is capable of executing the software components described herein for the exemplary method or systems. In an embodiment, the computing device may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device to provide the functionality of a number of servers that are not directly bound to the number of computers in the computing device. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or can be hired on an as-needed basis from a third-party provider. Some cloud computing environments may comprise cloud computing resources owned and operated by the enterprise as well as cloud computing resources hired and/or leased from a third-party provider.

In its most basic configuration, a computing device includes at least one processing unit and system memory. Depending on the exact configuration and type of computing device, system memory may be volatile (such as random-access memory (RAM)), non-volatile (such as read-only memory (ROM), flash memory, etc.), or some combination of the two.

The processing unit may be a standard programmable processor that performs arithmetic and logic operations necessary for the operation of the computing device. While only one processing unit is shown, multiple processors may be present. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device may also include a bus or other communication mechanism for communicating information among various components of the computing device.

Computing devices may have additional features/functionality. For example, the computing device may include additional storage such as removable storage and non-removable storage including, but not limited to, magnetic or optical disks or tapes. Computing devices may also contain network connection(s) that allow the device to communicate with other devices, such as over the communication pathways described herein. The network connection(s) may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing devices may also have input device(s) such as keyboards, keypads, switches, dials, mice, trackballs, touch screens, voice recognizers, card readers, paper tape readers, or other well-known input devices. Output device(s) such as printers, video monitors, liquid crystal displays (LCDs), touch screen displays, displays, speakers, etc., may also be included. The additional devices may be connected to the bus in order to facilitate the communication of data among the components of the computing device. All these devices are well known in the art and need not be discussed at length here.

The processing unit may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example tangible, computer-readable media may include but is not limited to volatile media, non-volatile media, removable media, and non-removable media implemented in any method or technology for storage of information such as computer-readable instructions, data structures, program modules, or other data. System memory, removable storage, and non-removable storage are all examples of tangible computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In light of the above, it should be appreciated that many types of physical transformations take place in the computer architecture in order to store and execute the software components presented herein. It also should be appreciated that the computer architecture may include other types of computing devices, including hand-held computers, embedded computer systems, personal digital assistants, and other types of computing devices known to those skilled in the art.

In an example implementation, the processing unit may execute program code stored in the system memory. For example, the bus may carry data to the system memory, from which the processing unit receives and executes instructions. The data received by the system memory may optionally be stored on the removable storage or the non-removable storage before or after execution by the processing unit.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including,” it means that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications, and publications, as listed below and throughout this document, are hereby incorporated by reference in their entirety herein.
[1] I. Singh, V. Blukis, A. Mousavian, A. Goyal, D. Xu, J. Tremblay, D. Fox, J. Thomason, A. Garg, ProgPrompt: Generating Situated Robot Task Plans using Large Language Models, ArXiv preprint arXiv:2209.11302.
[2] C. H. Song, J. Wu, C. Washington, B. M. Sadler, W.-L. Chao, Y. Su, LLM-Planner: Few-Shot Grounded Planning for Embodied Agents with Large Language Models, ArXiv preprint arXiv:2212.04088.
[3] Arnaiz-Gonz'alez, 'A., D'iez-Pastor, J.-F., Ramos-P'erez, I., & Garc'ia-Osorio, C. (2018). Seshat—a web-based educational resource for teaching the most common algorithms of lexical analysis. Computer Applications in Engineering Education, 26 (6), 2255-2265.
[4] Baier, C., & Katoen, J.-P. (2008). Principles of Model Checking. MIT Press. Baral, C., Dzifcak, J., Gonzalez, M. A., & Zhou, J. (2011). Using inverse lambda and generalization to translate english to formal languages. In International Conference on Computational Semantics, pp. 35-44.
[5] Brouwer, K., Gellerich, W., & Pl\ddot{ }odereder, E. (1998). Myths and facts about the efficient implementation of finite automata and lexical analysis. In Compiler Construction, Vol. 1383 of Lecture Notes in Computer Science, pp. 1-15.
[6] Brown, T. B., Mann, B., Ryder, N., Subbiah, M., Kaplan, J., Dhariwal, P., Neelakantan, A., Shyam, P., Sastry, G., Askell, A., Agarwal, S., Herbert-Voss, A., Krueger, G., Henighan, T., Child, R., Ramesh, A., Ziegler, D. M., Wu, J., Winter, C., Hesse, C., Chen, M., Sigler, E., Litwin, M., Gray, S., Chess, B., Clark, J., Berner, C., McCandlish, S., Radford, A., Sutskever, I., & Amodei, D. (2020). Language models are few-shot learners. Advances in Neural Information Processing Systems, 33, 1877-1901.
[7] Cimatti, A., Clarke, E. M., Giunchiglia, E., Giunchiglia, F., Pistore, M., Roveri, M., Sebastiani, R., & Tacchella, A. (2002). NuSMV 2: An opensource tool for symbolic model checking. In Computer Aided Verification, Vol. 2404 of Lecture Notes in Computer Science, pp. 359-364.
[8] Davison, J., Feldman, J., & Rush, A. M. (2019). Commonsense knowledge mining from pretrained models. In Conference on Empirical Methods in Natural Language Processing, pp. 1173-1178.
[9] Fang, X., Wang, J., Yin, C., Han, Y., & Zhao, Q. (2020). Multiagent reinforcement learning with learning automata for microgrid energy management and decision optimization. In Chinese Control and Decision Conference, pp. 779-784.
[10] Francis, J., Kitamura, N., Labelle, F., Lu, X., Navarro, I., & Oh, J. (2022). Core challenges in embodied vision-language planning. J. Artif. Intell. Res., 74, 459-515.
[11] Ghosh, S., Elenius, D., Li, W., Lincoln, P., Shankar, N., & Steiner, W. (2016). ARSENAL: automatic requirements specification extraction from natural language. In NASA Formal Methods, Vol. 9690 of Lecture Notes in Computer Science, pp. 41-46.
[12] He, M., Fang, T., Wang, W., & Song, Y. (2022). Acquiring and modelling abstract commonsense knowledge via conceptualization.
[13] Hendrycks, D., Burns, C., Basart, S., Zou, A., Mazeika, M., Song, D., & Steinhardt, J. (2021). Measuring massive multitask language understanding. In International Conference on Learning Representations.
[14] Honnibal, M., Montani, I., Van Landeghem, S., & Boyd, A. (2020). spacy: Industrial strength natural language processing in python.
[15] Huang, W., Abbeel, P., Pathak, D., & Mordatch, I. (2022a). Language models as zero-shot planners: Extracting actionable knowledge for embodied agents. In International Conference on Machine Learning, Vol. 162 of Proceedings of Machine Learning Research, pp. 9118-9147.
[16] Huang, W., Xia, F., Xiao, T., Chan, H., Liang, J., Florence, P., Zeng, A., Tompson, J., Mordatch, I., Chebotar, Y., Sermanet, P., Jackson, T., Brown, N., Luu, L., Levine, S., Hausman, K., & Ichter, B. (2022b). Inner monologue: Embodied reasoning through planning with language models. In Conference on Robot Learning, Vol. 205 of Proceedings of Machine Learning Research, pp. 1769-1782.
[17] Icarte, R. T., Klassen, T. Q., Valenzano, R. A., & McIlraith, S. A. (2018). Using reward machines for high-level task specification and decomposition in reinforcement learning.
[18] In Dy, J. G., & Krause, A. (Eds.), International Conference on Machine Learning, Vol. 80 of Proceedings of Machine Learning Research, pp. 2112-2121.
[19] Ichter, B., Brohan, A., Chebotar, Y., Finn, C., Hausman, K., Herzog, A., Ho, D., Ibarz, J., Irpan, A., Jang, E., Julian, R., Kalashnikov, D., Levine, S., Lu, Y., Parada, C., Rao, K., Sermanet, P., Toshev, A., Vanhoucke, V., Xia, F., Xiao, T., Xu, P., Yan, M., Brown, N., Ahn, M., Cortes, O., Sievers, N., Tan, C., Xu, S., Reyes, D., Rettinghouse, J., Quiambao, J., Pastor, P., Luu, L., Lee, K., Kuang, Y., Jesmonth, S., Joshi, N. J., Jeffrey, K., Ruano, R. J., Hsu, J., Gopalakrishnan, K., David, B., Zeng, A., & Fu, C. K. (2022). Do as I can, not as I say: Grounding language in robotic affordances. In Conference on Robot Learning, Vol. 205 of Proceedings of Machine Learning Research, pp. 287-318.
[20] Kate, R. J., Wong, Y. W., & Mooney, R. J. (2005). Learning to transform natural to formal languages. In National Conference on Artificial Intelligence, pp. 1062-1068.
[21] Kucera, H., Francis, W. N., Twaddell, W. F., Marckworth, M. L., Bell, L. M., & Carroll, J. B. (1967). Computational analysis of present-day american english. International Journal of American Linguistics, 35, 71-75.
[22] Lu, Y., Feng, W., Zhu, W., Xu, W., Wang, X. E., Eckstein, M., & Wang, W. Y. Neuro-symbolic procedural planning with commonsense prompting, in International Conference on Learning Representations, 2023.
[23] Narendra, K. S., & Thathachar, M. A. L. (1974). Learning automata—a survey. IEEE Transactions on Systems, Man, and Cybernetics, 4 (4), 323-334.
[24] Neary, C., Xu, Z., Wu, B., & Topcu, U. (2021). Reward machines for cooperative multiagent reinforcement learning. In International Conference on Autonomous Agents and MultiAgent Systems, AAMAS '21, p. 934-942.
[25] Neider, D., Gaglione, J., Gavran, I., Topcu, U., Wu, B., & Xu, Z. (2021). Advice-guided reinforcement learning in a non-markovian environment. In AAAI Conference on Artificial Intelligence, pp. 9073-9080.
[26] Petroni, F., Rockt\ddot{ }aschel, T., Riedel, S., Lewis, P., Bakhtin, A., Wu, Y., & Miller, A. (2019). Language models as knowledge bases?. In Conference on Empirical Methods in Natural Language Processing, pp. 2463-2473.
[27] Pnueli, A. (1977). The temporal logic of programs. In Symposium on Foundations of Computer Science, pp. 46-57.
[28] Rezaei, N., & Reformat, M. Z. (2022). Utilizing language models to expand vision-based commonsense knowledge graphs. Symmetry, 14, 1715.
[29] Sadoun, D., Dubois, C., Ghamri-Doudane, Y., & Grau, B. (2013). From natural language requirements to formal specification using an ontology. In International Conference on Tools with Artificial Intelligence, pp. 755-760.
[30] Shah, D., Osinski, B., Ichter, B., & Levine, S. (2022). Lm-nav: Robotic navigation with large pre-trained models of language, vision, and action. In Conference on Robot Learning, Vol. 205 of Proceedings of Machine Learning Research, pp. 492-504.
[31] Thomason, J., Padmakumar, A., Sinapov, J., Walker, N., Jiang, Y., Yedidsion, H., Hart, J. W., Stone, P., & Mooney, R. J. (2020). Jointly improving parsing and perception for natural language commands through human-robot dialog. J. Artif. Intell. Res., 67, 327-374.
[32] Vadera, S., & Meziane, F. (1994). From english to formal specifications. The Computer Journal, 37, 753-763.
[33] Valkanis, A., Beletsioti, G. A., Nicopolitidis, P., Papadimitriou, G., & Varvarigos, E. A. (2020). Reinforcement learning in traffic prediction of core optical networks using learning automata. In International Conference on Communications, Computing, Cybersecurity.
[34] Vardi, M. Y., & Wolper, P. (1986). An automata-theoretic approach to automatic program verification (preliminary report). In Symposium on Logic in Computer Science, pp. 332-344.
[35] Vasileiou, S. L., Yeoh, W., Son, T. C., Kumar, A., Cashmore, M., & Magazzeni, D. (2022). A logic-based explanation generation framework for classical and hybrid planning problems. J. Artif. Intell. Res., 73, 1473-1534.
[36] Vemprala, S., Bonatti, R., Bucker, A., & Kapoor, A. (2023). ChatGPT for robotics: Design principles and model abilities. Published by Microsoft.
[37] West, P., Bhagavatula, C., Hessel, J., Hwang, J. D., Jiang, L., Bras, R. L., Lu, X., Welleck, S., & Choi, Y. (2022). Symbolic knowledge distillation: from general language models to commonsense models. In Conference of the North American Chapter of the Association for Computational Linguistics: Human Language Technologies, pp. 4602-4625.
[38] Xiong, W., Du, J., Wang, W. Y., & Stoyanov, V. (2020). Pretrained encyclopedia: Weakly supervised knowledge-pretrained language model. In International Conference on Learning Representations.
[39] Xu, Z., Gavran, I., Ahmad, Y., Majumdar, R., Neider, D., Topcu, U., &Wu, B. (2020). Joint inference of reward machines and policies for reinforcement learning. In International Conference on Automated Planning and Scheduling, pp. 590-598.
[40] Zhang, Z., Wang, D., & Gao, J. (2021). Learning automata-based multiagent reinforcement learning for optimization of cooperative tasks. IEEE Transactions on Neural Networks and Learning Systems, 32, 4639-4652.
[41] Bo Liu, Yuqian Jiang, Xiaohan Zhang, Qiang Liu, Shiqi Zhang, Joydeep Biswas, and Peter Stone. 2023. “LLM+ P: Empowering Large Language Models with Optimal Planning Proficiency.” arXiv preprint arXiv:2304.11477.
[42] Yuhuai Wu, Albert Qiaochu Jiang, Wenda Li, Markus Rabe, Charles Staats, Mateja Jamnik, and Christian Szegedy. 2022. “Autoformalization with Large Language Models.” Advances in Neural Information Processing Systems 35: 32353-32368.

1. A method for a human-machine interface comprising:
receiving text data associated with a command of a user having a natural language sentence for a task of interest;
generating, via a controller engine in a pipeline operation performed by the controller engine using the received text data, an automaton controller configured to perform constrained sequential decision-making for the task of interest, wherein the generation comprises:
iteratively querying, in the pipeline operation, a trained generative language model (GLM) with one or more structured-natural-language queries for (i) a task description of the task of interest and (ii) a step-by-step subtask instruction description, wherein the task description and the step-by-step subtask instruction description are arranged as a structured hierarchy of steps and substeps for the task of interest;
parsing, for language phrase objects and transition objects, (i) the task description to generate a set of first textual data objects and (ii) the step-by-step subtask instruction description to generate a set of second textual data objects;
generating a finite state automaton comprising a data structure that includes at least one of (i) input data objects corresponding to environment observations, (ii) output data objects corresponding to actions for the task, (iii) initial stage, and (iv) transition function; and
determining, in a verification operation, whether a finite state automata satisfy a set of one or more pre-defined requirements expressed in temporal logic and maintained by a constraint engine, wherein the verification operation checks the data structure against the set of pre-defined requirements; and
outputting the finite state automata as a state machine for the automaton controller if the checked data structure satisfies the set of pre-defined one or more requirements, wherein the automaton controller is employed as a part of executable instructions to direct machine processes or equipment to perform the task of interest.

2. The method of claim 1, further comprising;
revising the finite state automata if the checked data structure is deficient in satisfying the set of pre-defined one or more requirements, wherein the revision employs adding supplemental data structure based on a counter-example explaining controller deficiency.

3. The method of claim 2, further comprising:
determining an output associated with the counter-example; and
generating the output to the user associated with the counter-example.

4. The method of claim 2, further comprising:
iteratively querying, in the pipeline operation, the trained generative language model (GLM) for an output associated with the counter-example.

5. The method of claim 1, wherein the verification operation expands the substeps for the task of interest until the checked data structure satisfies the set of pre-defined one or more requirements or until a maximum depth is reached.

6. The method of claim 4, wherein the step of iteratively querying further includes:
parsing, via a first operation, the first textual data object to extract keywords, including verb phrases and connective keywords, to define atomic propositions, output symbols, and transitions.

7. The method of claim 1, wherein the one or more structured-natural-language queries are generated via an algorithm that:
(i) generates a first query string based on an extracted portion associated with the task of interest of the received text data;
(ii) receives a set of one or more responses, as step objects, from the trained generative language model, as the first textual data object;
(iii) iteratively generates, for each response of the received set of one or more responses, a second query string derived from the respective response; and
(iv) receives a set of one or more responses, as substep objects, from the trained generative language model as the second textual data object.

8. The method of claim 1, wherein the transition function includes direct transition, conditional transition, and self-transition.

9. The method of claim 7, wherein the one or more structured-natural-language queries include a domain-specific knowledge indicator or constraint.

10. A system comprising:
a processor; and
a memory having instructions stored thereon to execute a human-machine interface, wherein execution of the instructions by the processor causes the processor to:
receive text data associated with a command of a user having a natural language sentence for a task of interest;
generate, via a controller engine in a pipeline operation performed by the controller engine using the received text data as a task of interest, an automaton controller configured to perform constrained sequential decision-making for the task of interest, wherein the generation comprises:
iteratively query, in the pipeline operation, a trained generative language model (GLM) with one or more structured-natural-language queries for (i) a task of interest and (ii) a step-by-step task instruction description, wherein a natural-language description and the step-by-step task instruction description are arranged as a structured hierarchy of steps and substeps for the task of interest;
parse, for language phrase objects and transition objects, (i) the natural-language description to generate a set of first textual data objects and (ii) the step-by-step task instruction description to generate a set of second textual data objects;
generate a finite state automaton, as linear temporal logic, comprising a data structure that includes at least (i) input data objects corresponding to actions for a task, (ii) output data objects corresponding to environment observations, (iii) initial stage, and (iv) transition function; and
determine, in a verification operation, whether finite state automata satisfy a set of one or more pre-defined requirements maintained by a constraint engine, wherein the verification operation checks the data structure against the set of pre-defined requirements; and
output the finite state automata as a state machine for the automaton controller if the checked data structure satisfies the set of pre-defined one or more requirements, wherein the automaton controller is employed as a part of executable instructions to direct machine processes or equipment to perform the task of interest.

11. The system of claim 10, wherein the instructions further cause the processor to:
revise the finite state automata if the checked data structure is deficient in satisfying the set of pre-defined one or more requirements, wherein the revision employs adding supplemental data structure based on a counter-example explaining controller deficiency.

12. The system of claim 11, wherein the instructions to revise the finite state automata include:
instructions to determine an output associated with the counter-example; and
instructions to generate the output to the user associated with the counter-example.

13. The system of claim 11, wherein the instructions to revise the finite state automata include:
iteratively query, in the pipeline operation, the trained generative language model (GLM) for an output associated with the counter-example.

14. The system of claim 10, wherein the verification operation, or a separate operation, iteratively expands the substeps for the task of interest until the checked data structure satisfies the set of pre-defined one or more requirements or until a maximum depth is reached.

15. The system of claim 10, wherein the instruction to iteratively query includes:
instructions to parse, via a first operation, the first textual data object to extract keywords, including verb phrases and connective keywords, to define atomic propositions, output symbols, and transitions.

16. The system of claim 10, wherein the one or more structured-natural-language queries is generated via an algorithm that:
(i) generates a first query string based on an extracted portion associated with the task of interest of the received text data;
(ii) receives a set of one or more responses, as step objects, from the trained generative language model, as the first textual data object;
(iii) iteratively generates, for each response of the of the received set of one or more responses, a second query string derived from the respective response; and
(iv) receives a set of one or more responses, as substep objects, from the trained generative language model as the second textual data object.

17. The system of claim 10, wherein the transition function includes direct transition, conditional transition, and self-transition.

18. The system of claim 16, wherein the one or more structured-natural-language queries include a domain-specific knowledge indicator or constraint.

19. A non-transitory computer-readable medium having instructions stored thereon to execute a human-machine interface, wherein execution of the instructions by a processor causes the processor to:
receive text data associated with a command of a user having a natural language sentence for a task of interest;
generate, via a controller engine in a pipeline operation performed by the controller engine using the received text data as a task of interest, an automaton controller configured to perform constrained sequential decision-making for the task of interest, wherein the generation comprises:
iteratively query, in the pipeline operation, a trained generative language model (GLM) with one or more structured-natural-language queries for (i) a task of interest and (ii) a step-by-step task instruction description, wherein a natural-language description and the step-by-step task instruction description are arranged as a structured hierarchy of steps and substeps for the task of interest;
parse, for language phrase objects and transition objects, (i) the natural-language description to generate a set of first textual data objects and (ii) the step-by-step task instruction description to generate a set of second textual data objects;
generate a finite state automaton, as linear temporal logic, comprising a data structure that includes at least (i) input data objects corresponding to actions for a task, (ii) output data objects corresponding to environment observations, (iii) initial stage, and (iv) transition function; and
determine, in a verification operation, whether finite state automata satisfy a set of one or more pre-defined requirements maintained by a constraint engine, wherein the verification operation checks the data structure against the set of pre-defined requirements; and
output the finite state automata as a state machine for the automaton controller if the checked data structure satisfies the set of pre-defined one or more requirements, wherein the automaton controller is employed as a part of executable instructions to direct machine processes or equipment to perform the task of interest.

20. The non-transitory computer-readable medium of claim 19, wherein the instructions further cause the processor to:
revise the finite state automata if the checked data structure is deficient in satisfying the set of pre-defined one or more requirements, wherein the revision employs adding supplemental data structure based on a counter-example explaining controller deficiency.
